(19) United States
(12) Patent Application Publication
(10) Pub. No.: US 2025/0315894 A1
(43) Pub. Date: Oct. 9, 2025

(54) COMPUTER-IMPLEMENTED METHODS AND SYSTEMS FOR SECURE DIGITAL ASSET TOKENIZATION AND TRANSFER USING DISTRIBUTED LEDGER TECHNOLOGY

(71) Applicant: Web3 Freedom Club DAO LLC, Casper, WY (US)

(72) Inventors: Jason Younker, Northglenn, CO (US); Tyler Younker, Northglenn, CO (US)

(73) Assignee: Web3 Freedom Club DAO LLC, Casper, WY (US)

(21) Appl. No.: 19/174,360

(22) Filed: Apr. 9, 2025

Related U.S. Application Data
(60) Provisional application No. 63/631,898, filed on Apr. 9, 2024.

(51) Int. Cl. G06Q 40/06; G06Q 20/36; G07C 13/00

(52) U.S. Cl. CPC G06Q 40/06; G06Q 20/36; G07C 13/00; G06Q 2230/00

(57) ABSTRACT

A method for creating and exchanging tokenized assets combines a dual ownership structure with a tiered exchange system. The method involves issuing membership non-fungible tokens to cooperative members, creating a tokenized asset through a legal entity and property ownership non-fungible token, and implementing a smart contract to generate property tokens representing fractional ownership. The exchange system for these property tokens implements sequential buying windows, providing initial exclusive access to non-token holders, followed by access to regional cooperative members, then global cooperative members, and finally institutional buyers. This approach may promote progressive decentralization of ownership while maintaining secure blockchain-based transfers within the cooperative framework. The method may enable fractional ownership of various assets, automated distribution of benefits, and a controlled secondary market structure that balances liquidity provision with ownership diversification.

### CROSS-REFERENCE TO RELATED APPLICATIONS

This application claims priority to U.S. Prov. Pat. App. No. 63/631,898, filed on Apr. 9, 2024, entitled, “Methods for the Cooperative Ownership of Various Types of Property Using Blockchain Tokens,” which is hereby incorporated by reference in its entirety.

### BACKGROUND

In recent years, the concept of fractional ownership has gained traction across various asset classes, including real estate, vehicles, and other high-value properties. This model allows multiple parties to share ownership of an asset, potentially reducing individual financial burdens and increasing accessibility to investments that might otherwise be out of reach. As technology continues to evolve, there is growing interest in leveraging digital platforms and blockchain technology to facilitate and manage these ownership structures.

Traditional approaches to fractional ownership often involve complex legal structures, such as limited liability companies or partnerships, to manage shared assets. While these methods can be effective, they frequently present challenges in terms of administration, transparency, and liquidity. For instance, tracking ownership stakes, distributing profits, and facilitating transfers between parties can be cumbersome and time-consuming processes. Additionally, the lack of standardization across different ownership structures can make it difficult for investors to compare opportunities or easily move between investments. Furthermore, the reliance on centralized record-keeping systems can introduce concerns about data security and the potential for errors or manipulation.

These limitations underscore the need for innovative solutions that can streamline the creation, management, and transfer of fractional ownership rights. A system that addresses these challenges could potentially enhance the efficiency, transparency, and accessibility of fractional ownership across various asset classes, while also providing robust security measures to protect investors' interests.

### SUMMARY

One embodiment of the present invention relates to a method for creating a tokenized asset within a cooperative structure. This method involves issuing membership non-fungible tokens to cooperative members as proof of their membership. When the cooperative approves the acquisition of an asset, a dual ownership structure is created. This structure includes establishing a legal entity for asset ownership and generating a property ownership non-fungible token associated with the asset. Additionally, a smart contract is implemented to create property tokens that represent fractional ownership in the tokenized asset. The property ownership non-fungible token and the legal entity together form parallel digital and legal ownership structures for the asset. This approach may enable secure and efficient management of fractional ownership rights using blockchain technology while maintaining traditional legal protections.

Another embodiment of the present invention relates to a method for operating a property token exchange. This method involves receiving a listing of property tokens for sale from a cooperative member, where the tokens represent fractional ownership in a tokenized asset created through a dual ownership structure. The method implements a series of sequential buying windows for the listed tokens. Initially, exclusive bidding access is provided to non-holders of property tokens for a set time period. After this period expires, access to bid on unsold tokens is granted to cooperative members within the regional geolocation of the tokens. Subsequently, bidding access is extended to cooperative members located anywhere. The method concludes by executing the transfer of sold property tokens between the wallets of buyers and sellers via blockchain technology. This approach may promote progressive decentralization of ownership while maintaining a controlled and secure secondary market for property tokens within the cooperative framework.

Other features and advantages of various aspects and embodiments of the present invention will become apparent from the following description and from the claims.

### BRIEF DESCRIPTION OF THE DRAWINGS

FIG. 1 is a flowchart showing the process flow for a generalized blockchain transaction.

FIG. 2A is a flowchart illustrating a method for creating a tokenized asset within a cooperative structure according to one embodiment of the present invention.

FIG. 2B is a flowchart depicting a method for issuing membership non-fungible tokens to cooperative members according to one embodiment of the present invention.

FIG. 2C is a flowchart showing a method for approving asset acquisition within the cooperative according to one embodiment of the present invention.

FIG. 2D is a flowchart illustrating an asset acquisition process within a cooperative organization according to one embodiment of the present invention.

FIG. 3 is a system diagram of a tokenized asset creation system according to one embodiment of the present invention.

FIG. 4A is a flowchart illustrating a method for implementing sequential buying windows for property tokens according to one embodiment of the present invention.

FIG. 4B is a flowchart depicting a method for providing access to institutional buyers after previous buying windows have concluded according to one embodiment of the present invention.

FIG. 4C is a flowchart showing a method for verifying token lockup period expiration before implementing sequential buying windows according to one embodiment of the present invention.

FIG. 5 is a system diagram of a property token exchange system according to one embodiment of the present invention.

### DETAILED DESCRIPTION

Web3 blockchain technology represents the evolution of decentralized systems beyond their current forms. It aims to create a more interconnected, secure, and user-centric internet experience by leveraging blockchain technology, decentralized protocols, and cryptographic principles. Web3 blockchain technology operates on decentralized networks where no single entity controls the entire system. Participants in the network that validate transactions and propose new blocks to be added to the blockchain are called validators or nodes. The rules and algorithms that govern how nodes communicate, propose, validate, and agree on the state of the blockchain is called the consensus protocol. Incentive structures incentivize nodes to act honestly and follow the consensus protocol's rules, typically through rewards or penalties. Web3 blockchain technology relies on a network of nodes that work together to validate and record transactions. The core of Web3 technology is a distributed ledger, a tamper-resistant database that stores a continuously growing list of records, or blocks, linked and secured using cryptographic hashes.

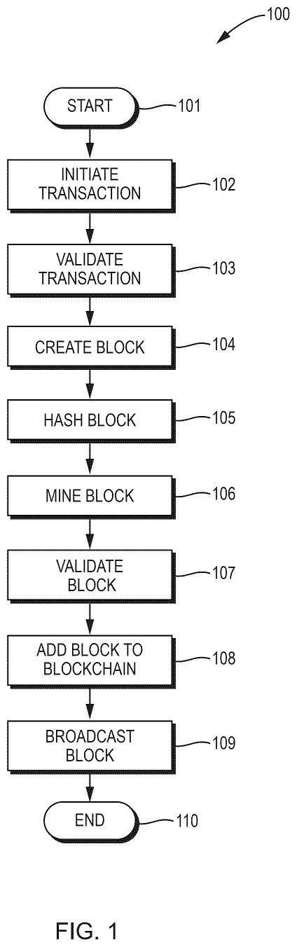

FIG. 1 shows the process flow 100 for a generalized blockchain transaction. The transaction starts at step 101. At step 102, a user creates a transaction request to transfer cryptocurrency assets, using the platform that the user has selected for processing the user's cryptocurrency transactions. At step 103, the platform verifies the authenticity of the user and validity of the transaction request. Optionally, this step may include the substeps of checking for double spending and ensuring the user has sufficient funds. At step 104, the platform communicates the transaction to a blockchain node to create a block. The node assembles a block containing multiple validated transactions and including a reference to the previous block, thereby creating a chain. At step 105, the node hashes the block, in which the node applies a cryptographic hash function to the block data and generates a unique identifier, called a hash for the block.

At step 106, the node “mines” the block, meaning that the node performs a proof-of-work or other consensus mechanism to validate the block. Blockchain networks utilize consensus mechanisms to agree on the state of the ledger and validate transactions without relying on a central authority. Blockchain consensus mechanisms are fundamental to the operation of decentralized networks. They enable disparate nodes within the network to agree on the validity of transactions and the state of the ledger without relying on a central authority. Consensus mechanisms ensure the integrity, security, and immutability of the blockchain. Examples include Proof of Work (PoW), Proof of Stake (PoS), Delegated Proof of Stake (DPoS), and others. Regardless of the consensus mechanism employed, certain properties are required. First, the mechanism must be secure and must resist attacks and ensure the integrity of the blockchain. Second, the mechanism must be decentralized and validation power should be distributed among a diverse set of nodes to prevent centralization and maintain censorship resistance. Third, the consensus mechanism should be able to handle a large number of transactions and support network growth. Fourth, transactions should be irreversible once confirmed by the consensus mechanism.

The following are descriptions of the most commonly used consensus mechanisms. In Proof of Work (PoW), nodes are “miners” that compete to solve complex mathematical puzzles using computational power. The puzzle difficulty is dynamically adjusted to regulate the rate at which new blocks are added to the blockchain. The first node to solve the puzzle broadcasts the solution to the network. Other nodes verify the solution, and if valid, the new block is added to the blockchain. Miners are rewarded with cryptocurrency for successfully adding a block to the chain. In Proof of Work systems, a single entity controlling more than 50% of the network's computational power can compromise the integrity of the blockchain. PoW consensus mechanisms must be designed to resist such attacks. In Proof of Stake (PoS), validators lock up a certain amount of cryptocurrency as stake to participate in block validation. Validators are chosen to create new blocks based on factors like the amount of stake they hold and the length of time they have held it. Validators propose and validate new blocks. The weight of their validation rights is determined by their stake. Validators receive transaction fees and sometimes block rewards for their participation. Proof of Work mechanisms consume substantial computational power, leading to environmental concerns; Proof of Stake mechanisms aim to mitigate this issue. In Delegated Proof of Stake (DPoS), token holders vote to elect a set number of delegates who will validate transactions and create new blocks. Token holders can delegate their voting power to specific delegates. Elected delegates take turns producing blocks and validating transactions. Delegates earn rewards for their block production efforts.

Turning again to FIG. 1, at step 107, other nodes in the network validate the mined block. The consensus mechanisms discussed above ensure agreement on the validity of the block. At step 108, if the block is validated, it is appended to the existing blockchain. At step 109, the new block is propagated to all nodes in the network, to ensure all nodes have the latest version of the blockchain. The process ends at step 110.

In addition to the generalized blockchain transaction shown in FIG. 1, Web3 technology layers on several additional features. Web3 technology allows for execution of smart contracts, which are self-executing contracts with the terms of the agreement directly written into code. Smart contracts run on the blockchain and automatically enforce the terms when predefined conditions are met. Web3 technology also relies heavily on cryptographic algorithms to secure transactions and data. Public-private key pairs, digital signatures, and cryptographic hashes ensure the integrity, authenticity, and confidentiality of transactions and communications. Web3 further aims to enable interoperability between different blockchain networks and protocols, allowing seamless communication and value transfer across disparate platforms. Web3 technology also allows for decentralized applications (“DApps”) which are applications built on top of blockchain networks that leverage smart contracts and decentralized protocols. They provide users with transparent, censorship-resistant, and trustless access to various services. Finally, Web3 networks rely on peer-to-peer (P2P) networking protocols to facilitate direct communication and data transfer between nodes. P2P networks ensure fault tolerance, scalability, and resistance to censorship or attacks.

Ethereum is one of the most prominent platforms for building decentralized applications and smart contracts. It introduced the concept of Turing-complete smart contracts, enabling developers to create complex, programmable applications. Ethereum introduced various token standards that define how tokens are created, transferred, and managed on the blockchain. These standards ensure interoperability among different applications, wallets, and platforms, allowing tokens to be seamlessly exchanged and utilized across various decentralized applications (DApps) and blockchain networks. Some of the prominent web3 token standards include ERC-20, ERC-721, and ERC-1155 in the Ethereum ecosystem.

Ethereum Request for Comment 20, or ERC-20, is one of the most widely adopted token standards on the Ethereum blockchain, enabling the creation and management of fungible tokens. Fungible tokens are interchangeable and identical, allowing for seamless exchange and transferability. ERC-20 tokens adhere to a defined set of functions, including balance inquiries, transfers, and approvals, ensuring compatibility with a wide range of wallets and decentralized exchanges (DEXs). Notable features include the total supply of tokens, balance tracking, allowance mechanism, and transfer functionalities.

Ethereum Request for Comment 721, or ERC-721, is a non-fungible token (NFT) standard on the Ethereum blockchain, designed for unique and indivisible digital assets. Each ERC-721 token is distinct and non-interchangeable, representing ownership or proof of authenticity for digital assets such as digital art, collectibles, and virtual real estate. ERC-721 tokens contain metadata that describes the characteristics and attributes of the underlying asset, providing additional context and value. They support functionalities such as token ownership transfer, approval mechanisms, and enumeration of token IDs.

Ethereum Request for Comment 1155, or ERC-1155, is a multi-token standard that combines the features of both ERC-20 and ERC-721, offering greater flexibility and efficiency in managing various types of assets. Unlike ERC-20 and ERC-721, ERC-1155 allows for the creation of both fungible and non-fungible tokens within the same contract, reducing gas costs and minimizing blockchain bloat. ERC-1155 contracts support batch transfers, enabling efficient management of multiple token types in a single transaction. It provides enhanced composability, enabling developers to create complex token ecosystems and asset structures with reduced overhead.

Decentralized Identity (“DID”) is a standard for creating and managing digital identities on the blockchain. It enables individuals to have full control over their personal data and identity, eliminating the need for centralized identity providers. DIDs are based on decentralized systems such as blockchain and distributed ledger technology (DLT), and they provide a standardized method for referencing and interacting with decentralized identity systems. DIDs are unique identifiers that are globally resolvable and are not dependent on any central authority for registration or maintenance. They are typically represented as a string of characters conforming to the DID specification, which includes a method-specific identifier and a method-specific DID scheme. DID methods define the rules and processes for creating, resolving, and managing DIDs within a specific decentralized network or technology stack. Examples of DID methods include DID:BTCR for Bitcoin, DID:ETH for Ethereum, and DID:SIDETREE for the Sidetree protocol. DIDs are often associated with decentralized identity infrastructures that provide the necessary tools and services for managing identity-related operations. These infrastructures typically include components such as decentralized identifier registries, resolution mechanisms, authentication protocols, and verifiable credential systems.

Each DID is associated with a DID document, which contains metadata and cryptographic keys related to the identity represented by the DID. The DID document provides information about the entity associated with the DID, including public keys for authentication, service endpoints for interaction, and other relevant metadata. DID resolution is the process of looking up and retrieving the DID document associated with a given DID. Resolvers are software components responsible for performing DID resolution, typically by querying decentralized networks, blockchain ledgers, or other distributed systems. DIDs can be used in conjunction with verifiable credentials, which are digitally signed statements attesting to the authenticity of identity-related information. Verifiable credentials enable individuals and entities to share selective pieces of information about themselves in a secure and privacy-preserving manner.

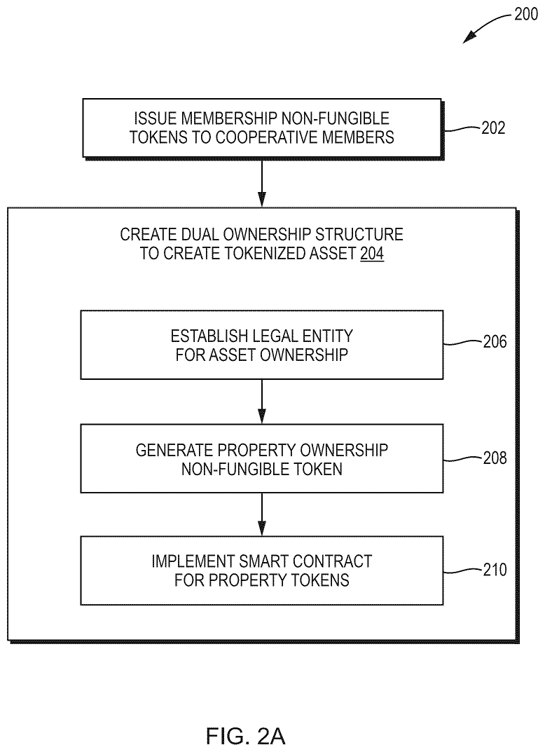

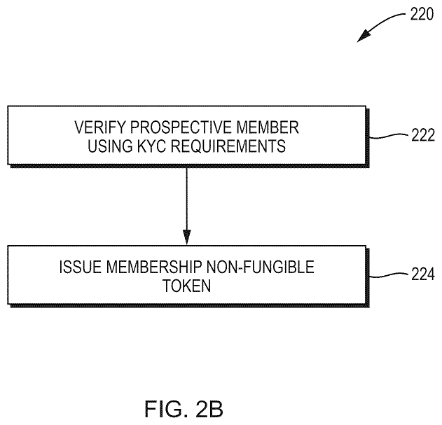

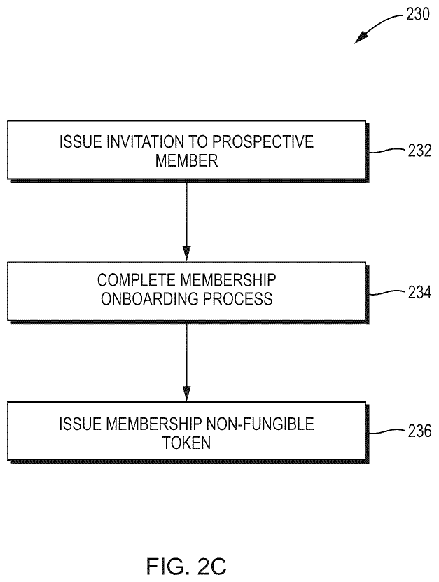

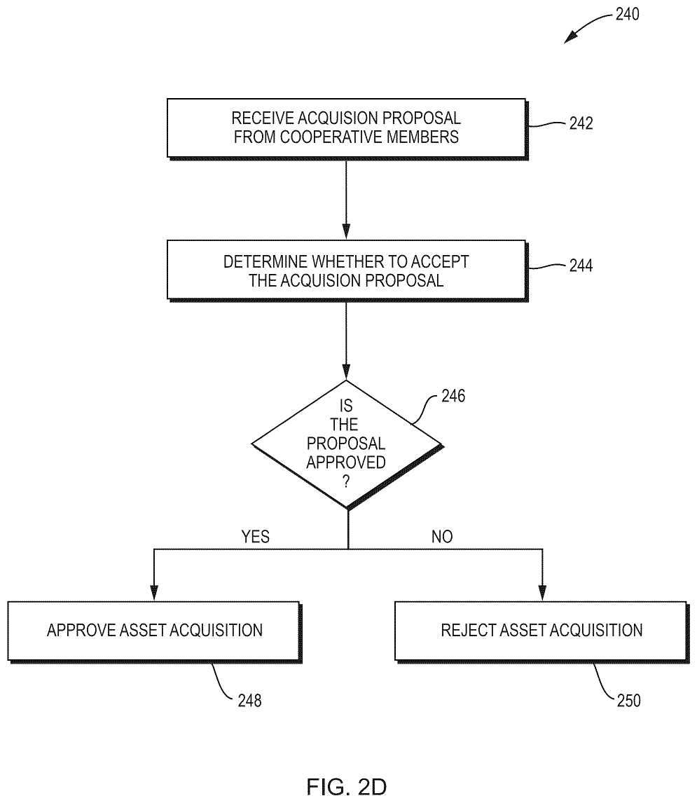

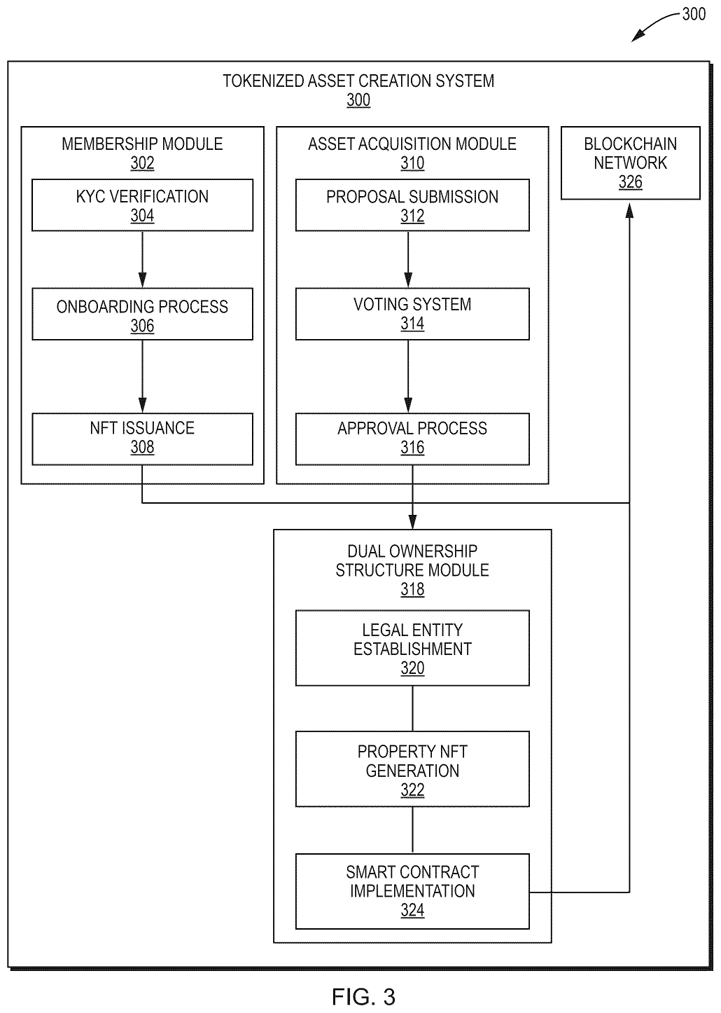

Referring to FIG. 2A, a flowchart is shown of a method 200 for creating a tokenized asset within a cooperative structure according to embodiments of the present invention. The method 200 may be performed by components of the tokenized asset creation system 300 shown in FIG. 3.

The method 200 begins with a step 202 of issuing, to each of a plurality of cooperative members, a corresponding membership non-fungible token (NFT) that serves as proof of membership in the cooperative. As a result, the step 202 issues a plurality of membership non-fungible tokens to the plurality of members of the cooperative. This step 202 may be performed by the membership module 302 of the tokenized asset creation system 300. In some embodiments, some or all of the membership NFTs may be implemented using an ERC-721 standard on a blockchain network.

Following the issuance of the plurality of membership tokens, the method 200 proceeds to a step 204 of creating a dual ownership structure for a tokenized asset. Step 204 may be performed in response to approving acquisition of an asset by the cooperative, as described in more detail below. Step 204 may include several sub-steps, including a step 206 of establishing a legal entity for asset ownership, a step 208 of generating a property ownership non-fungible token associated with the asset, and a step 210 of implementing a smart contract to create a plurality of property tokens representing fractional ownership in the tokenized asset. The property ownership non-fungible token associated with the asset and the legal entity together may establish parallel digital and legal ownership structures for the asset.

The parallel digital and legal ownership structures create a direct correspondence between the property ownership non-fungible token and the legal entity. This ensures the blockchain-based token accurately reflects the legal ownership structure, providing a verifiable link between digital and traditional legal records that facilitates tracking and management across both domains. Synchronization mechanisms may be used to maintain consistency between these structures when ownership changes occur. Smart contracts may be used to automate simultaneous updates to both blockchain tokens and legal entity records during ownership transfers, though designated authorities may sometimes perform manual interventions to ensure accuracy.

The step 206 of establishing a legal entity may be performed by the legal entity establishment component 320 of the dual ownership structure module 318. In some embodiments, this legal entity may take the form of a Special Purpose Vehicle (SPV).

The step 208 of generating a property ownership non-fungible token may be executed by the property NFT generation component 322. This token may represent digital ownership rights for the asset and may, for example, be implemented using an ERC-721 standard. As this implies, in some embodiments, both some or all of the membership tokens and some or all of the property ownership tokens may be implemented using the ERC-721 standard.

In some implementations, step 208 of generating the property ownership non-fungible token may involve creating a direct one-to-one relationship between the digital token and the legal ownership reflected in the established legal entity. This approach may ensure that the digital representation of ownership through the non-fungible token precisely mirrors the legal ownership structure. By maintaining this direct correspondence, the system may provide a clear and verifiable link between the blockchain-based token and the traditional legal ownership records. This alignment may facilitate easier tracking and management of ownership rights across both digital and legal domains. The one-to-one relationship may also simplify processes such as ownership transfers, audits, or dispute resolutions by providing a single source of truth for ownership status.

The step 210 of implementing a smart contract to create property tokens may be carried out by the smart contract Implementation component 324. In some embodiments, these property tokens may represent fractional ownership in the tokenized asset. Some or all of these property tokens may be implemented using an ERC-3643 standard.

While the membership and property ownership tokens disclosed herein are described as non-fungible tokens (NFTs), the property tokens representing fractional ownership may be implemented as fungible tokens using standards such as ERC-3643. Unlike NFTs, these fungible property tokens are interchangeable and divisible, allowing for more flexible representation of fractional ownership stakes. This distinction enables embodiments of the present invention to combine the unique identification capabilities of NFTs for membership and overall asset ownership with the divisibility and transferability benefits of fungible tokens for representing fractional ownership shares. The use of fungible tokens for property tokens may facilitate easier trading, division, and management of ownership stakes within the cooperative structure.

In implementing step 210, one approach may involve creating the property tokens such that each token represents an equal unit of value based on the initial property valuation of the asset. This method may provide a straightforward way to divide ownership of the asset into standardized, fungible units. For example, if an asset is initially valued at $1,000,000, the smart contract may create 1,000 fungible property tokens, each representing $1,000 worth of ownership. This approach may allow for easy calculation of ownership percentages and may simplify the process of buying, selling, or transferring fractional ownership stakes.

In some implementations, the smart contract may be implemented using a blockchain-based architecture that incorporates multiple token standards to support different aspects of the tokenized asset ecosystem. Specifically, the architecture may utilize the ERC-721 standard for both the membership non-fungible tokens and the property ownership non-fungible token. This standard is well-suited for representing unique, indivisible tokens such as individual memberships or singular property ownership rights. Concurrently, the architecture may employ the ERC-3643 standard for the property tokens that represent fractional ownership in the tokenized asset. The ERC-3643 standard, designed for security tokens, provides features that align with regulatory requirements and enable more complex ownership structures. By combining these standards within a single blockchain-based architecture, the smart contract can efficiently manage the various token types used in the cooperative's tokenized asset system, ensuring interoperability and compliance while leveraging the unique benefits of each token standard.

The use of equal-value tokens may also facilitate price discovery in secondary markets, as each token may represent a consistent portion of the overall asset value. Additionally, this method may provide clarity for investors, as they can easily understand the relationship between the number of tokens they hold and their stake in the overall asset. It is worth noting that the initial valuation used to determine token value may be based on various factors, such as professional appraisals, market comparisons, or other relevant metrics specific to the type of asset being tokenized. The smart contract may include provisions for updating token values in response to future revaluations of the underlying asset.

In implementing step 210, the smart contract may distribute the property tokens through various channels. One approach may involve using an investment club to handle the distribution of tokens. In this scenario, the investment club may act as an intermediary, managing the allocation and distribution of property tokens to its members or other eligible participants. Another method may utilize a property token associate acting as a registered representative. This individual or entity may be authorized to distribute the tokens on behalf of the cooperative, potentially leveraging their expertise in financial instruments and regulatory compliance to ensure proper distribution. Alternatively, the smart contract may facilitate token distribution through an indirect investment fund. In this case, the fund may acquire the property tokens and then offer shares or units to investors, effectively providing indirect exposure to the tokenized asset. These distribution methods may provide flexibility in how the property tokens reach potential investors, allowing the cooperative to tailor its approach based on regulatory requirements, investor preferences, or strategic objectives. The smart contract may incorporate logic to manage these distribution channels, ensuring that tokens are allocated and transferred according to predefined rules and conditions.

In implementing step 210, the smart contract may be designed as a security token contract. This approach may involve creating a specialized smart contract that adheres to regulatory requirements for security tokens. The security token contract may include features such as transfer restrictions, investor accreditation checks, and compliance with relevant securities laws. By implementing the smart contract as a security token contract, the system may provide a framework for managing the property tokens in a manner that aligns with legal and regulatory standards for securities. This may enable the cooperative to offer fractional ownership in the tokenized asset while maintaining compliance with applicable regulations. The security token contract may also incorporate functionality for dividend distribution, voting rights, and other features typically associated with traditional securities, but implemented in a blockchain-based environment.

Embodiments of the present invention may tokenize various types of assets. For example, the asset may be real property, such as a building. In other cases, the asset may be an automobile, a loan, energy infrastructure, or a business. Some additional variations and examples of assets that could be tokenized using this approach include intellectual property assets, such as patents, trademarks, or copyrights; natural resources, like mineral rights, timber stands, or water rights; agricultural assets, including farmland, orchards, or livestock herds; transportation infrastructure, such as toll roads, bridges, or ports; renewable energy projects, like solar farms or wind turbine installations; entertainment and media assets, such as film production rights, music catalogs, or sports teams; educational institutions or research facilities; healthcare assets, including medical equipment, pharmaceutical patents, or healthcare facilities; space-related assets, such as satellite systems, launch facilities, or even extraterrestrial mining rights; digital assets, including domain names, virtual real estate in metaverse platforms, or data centers; cultural heritage sites or artifacts; and luxury assets, such as fine art collections, rare wines, or classic automobiles. The flexibility of the tokenization process allows for the creation of diverse investment opportunities within the cooperative structure.

The membership non-fungible tokens issued in step 200 may serve multiple purposes within the cooperative. For instance, these tokens may enable blockchain-based voting on cooperative decisions. The property ownership non-fungible token generated in step 208 may establish digital ownership rights, while the property tokens created in step 208 may enable automated distribution of ownership benefits.

By implementing a blockchain-based architecture with specific token standards (such as ERC-721 for property ownership tokens and ERC-3643 for property tokens), embodiments of the method 200 may provide a secure, transparent, and efficient system for creating and managing tokenized assets within a cooperative structure.

Referring to FIG. 2B, a flowchart is shown of a method 220 for issuing the plurality of membership non-fungible tokens to the plurality of cooperative members according to embodiments of the present invention. The method 220 may be performed by components of the tokenized asset creation system 300 shown in FIG. 3, particularly the membership module 302.

The method 220 begins with a step 222 of verifying a prospective member of the cooperative, such as by using Know Your Customer (KYC) requirements. This verification step may be performed by the KYC Verification component 304 of the membership module 302. The KYC verification process may, for example, involve collecting and validating various pieces of information about the prospective member to ensure compliance with regulatory requirements and to establish the prospective member's identity. The KYC process may include document verification, in which the prospective member submits government-issued identification documents (such as passports, driver's licenses, or national ID cards), proof of address (such as utility bills or bank statements), and potentially financial information (such as tax identification numbers or bank account details). The system may employ optical character recognition (OCR) technology to extract data from submitted documents and compare it against trusted databases. Biometric verification may also be incorporated, including facial recognition technology that compares a live selfie with the photo on the submitted ID document, fingerprint scanning, or voice recognition. The KYC process may also include background checks against sanctions lists, politically exposed persons (PEP) databases, and adverse media screenings to assess risk factors. For enhanced security, the system may implement a multi-factor authentication process requiring verification through multiple channels, such as email confirmation codes and SMS verification. The KYC data may be securely stored using encryption and access controls to maintain compliance with data protection regulations such as GDPR or CCPA.

Alternative verification methods may also be employed instead of or in addition to KYC processes. One such alternative is decentralized identity verification, in which the system may leverage blockchain-based self-sovereign identity (SSI) solutions that allow prospective members to control their personal data while still providing verifiable credentials. The system may accept verifiable credentials issued by trusted third parties that attest to the prospective member's identity without revealing underlying personal data. Social verification may be implemented, where existing cooperative members vouch for or endorse new prospective members, creating a web of trust. This approach may be particularly suitable for community-based cooperatives where personal relationships are valued. The system may implement reputation-based verification systems that assess a prospective member's standing across various platforms or networks. Professional credential verification may be used, especially for cooperatives focused on specific industries, where professional licenses, certifications, or membership in recognized industry associations serve as proof of eligibility. For cooperatives with educational components, academic credential verification may be employed to confirm degrees, certificates, or course completions from accredited institutions. The system may accept digital signatures or electronic notarization as verification methods, particularly in jurisdictions where these carry legal weight equivalent to traditional notarized documents. In some implementations, the system may use a progressive verification approach, where basic verification grants limited membership rights, with additional verification steps used for expanded privileges or higher-value transactions within the cooperative.

Following the verification process, the method 220 proceeds to a step 224 of issuing a corresponding membership non-fungible token to the prospective member, who has now been verified. This step may be executed by the NFT issuance component 308 of the membership module 302. In some embodiments, the membership non-fungible tokens may be implemented using an ERC-721 standard on a blockchain network. The ERC-721 standard provides a set of rules for creating and managing non-fungible tokens on the Ethereum blockchain, ensuring that each token is unique and indivisible.

The membership non-fungible token serves as a digital proof of membership in the cooperative. By leveraging blockchain technology and the ERC-721 standard, embodiments of the present invention may provide a secure, transparent, and easily verifiable method of managing cooperative membership. Each membership token may contain metadata specific to the member, such as their verified identity information and/or membership status.

In some cases, the onboarding process component 306 of the membership module 302 may facilitate additional steps between the KYC verification and token issuance. For example, the onboarding process may include collecting additional information from the prospective member, explaining cooperative rules and responsibilities, or obtaining agreements or consents.

Embodiments of the method 220 may provide several advantages. For example, by using blockchain-based non-fungible tokens for membership representation, the cooperative may benefit from enhanced security, immutability of membership records, and the ability to easily verify membership status for various cooperative activities such as voting or asset acquisition decisions.

Referring to FIG. 2C, a flowchart is shown of a method 230 for issuing membership non-fungible tokens to cooperative members according to embodiments of the present invention. The method 230 may be performed by components of the tokenized asset creation system 300 shown in FIG. 3, particularly the membership module 302.

The method 230 begins with a step 232 of issuing an invitation to a prospective member of the cooperative. This step may be performed by the onboarding process component 306 of the membership module 302. In some cases, the invitation may be sent electronically over a telecommunications network, such as via email or through a dedicated application.

Following the issuance of the invitation, the method 230 proceeds to a step 234 of completing a membership onboarding process for the prospective member. This step may also be executed by the onboarding process component 306. The membership onboarding process may involve various activities, such as collecting information from the prospective member, explaining the cooperative's rules and responsibilities, and obtaining any agreements or consents.

After the completion of the membership onboarding process, the method 230 moves to a step 236 of issuing a corresponding membership non-fungible token to the prospective member. This step may be carried out by the NFT issuance component 308 of the membership module 302. By issuing the membership non-fungible token, the method 230 adds the prospective member to the plurality of members of the cooperative.

The issuance of membership non-fungible tokens in method 230 corresponds to the step 202 of the overall method 200 shown in FIG. 2A. In some cases, the membership non- fungible tokens may be implemented using an ERC-721 standard on a blockchain network, providing a secure and verifiable proof of membership in the cooperative.

Embodiments of the present invention may perform the method 230 of FIG. 2C for each of a plurality of prospective members of the cooperative. By repeating this process for multiple prospective members, the cooperative may issue a plurality of membership non-fungible tokens to the plurality of prospective members. This approach aligns with the step of issuing the plurality of membership non-fungible tokens described in the overall token asset creation method 200 of FIG. 2A.

In some implementations, the cooperative may process multiple prospective members concurrently, allowing for efficient scaling of the membership base. The onboarding process component 306 may manage multiple invitations and onboarding processes simultaneously, while the NFT issuance component 308 may generate and distribute membership tokens to multiple verified members in batches.

Embodiments of the method 230 may provide several advantages. For example, by using a structured onboarding process followed by the issuance of blockchain-based non-fungible tokens for membership representation, the cooperative may benefit from a streamlined member acquisition process and enhanced security of membership records. The use of non-fungible tokens may also facilitate various cooperative activities, such as voting or participation in asset acquisition decisions, by providing an easily verifiable membership status.

Referring to FIG. 2D, a flowchart is shown of a method 240 for handling asset acquisition proposals according to embodiments of the present invention. The method 240 may be performed by components of the tokenized asset creation system 300 shown in FIG. 3, particularly the asset acquisition module 310. The method 240 may, for example, be performed after issuing the plurality of membership non-fungible tokens in step 202 of FIG. 2A and before creating the dual ownership structure in step 204 of FIG. 2A.

The method 240 begins with a step 242 of receiving an acquisition proposal for an asset from one or more members of the cooperative. This step may be performed by the proposal submission component 312 of the asset acquisition module 310. In some cases, the proposal submission component 312 may utilize artificial intelligence to assist in shortlisting strategic assets for acquisition. For example, the Al system may analyze market trends, property valuations, and cooperative member preferences to identify potentially valuable assets for consideration.

Following the receipt of the acquisition proposal, the method 240 proceeds to a step 244 of determining whether to accept the acquisition proposal. This step may be executed by the voting system 314 of the asset acquisition module 310. In some embodiments, the determination may involve conducting a vote by the cooperative members on the acquisition proposal.

The voting process may utilize blockchain-based voting technology to record and verify member votes. The voting system 314 may verify voting eligibility based on ownership of the membership non-fungible tokens issued in step 202 of method 200 (FIG. 2A). In some cases, Al agents may be employed to automate aspects of the voting process, such as tallying votes or ensuring compliance with voting rules.

After the determination is made, the method 240 moves to a decision point 246, where the proposal is evaluated for approval. If the proposal is approved (Yes branch), the method 240 advances to a step 248 of approving the asset acquisition. This step may be carried out by the approval process component 316 of the asset acquisition module 310.

If the proposal is not approved (No branch), the method 240 instead proceeds to a step 250 of rejecting the asset acquisition. This step may also be performed by the approval process component 316.

In some embodiments, the voting system 314 may execute the vote according to governance rules specified in organizing documents of the cooperative. These rules may define voting thresholds, quorum requirements, or other parameters that govern the decision-making process for asset acquisitions.

The asset acquisition process described in method 240 may provide several advantages for embodiments of the present invention. For example, by leveraging blockchain-based voting technology and AI-assisted proposal evaluation, the cooperative may benefit from a transparent, efficient, and potentially more strategic approach to asset acquisition decisions. The use of membership non-fungible tokens for voting eligibility verification may also enhance the security and integrity of the voting process.

In some implementations, the voting system 314 may utilize blockchain-based voting technology to record and verify member votes. This voting mechanism may leverage the security and transparency features of blockchain technology to ensure fair and tamper-resistant decision-making within the cooperative structure. The voting process may involve several steps:
Vote Initiation: When an acquisition proposal or other decision requiring member input is submitted, the voting system 314 may automatically create a new voting event on the blockchain.
Eligibility Verification: The system may verify voting eligibility by checking the ownership of membership non-fungible tokens. Only members holding valid tokens may be allowed to participate in the vote.
Vote Casting: Eligible members may cast their votes through their personal devices. Each vote may be cryptographically signed using the member's private key associated with their membership token.
Vote Recording: As votes are cast, they may be recorded as individual transactions on the blockchain, ensuring immutability and traceability.
Real-time Tallying: The smart contract may automatically tally votes in real-time as they are recorded on the blockchain, providing instant updates on the voting progress.
Result Finalization: Once the voting period ends, the smart contract may automatically finalize the results, recording the outcome on the blockchain.
Result Verification: Any member may independently verify the voting results by querying the blockchain, enhancing transparency and trust in the decision-making process.

This automated voting mechanism may provide several benefits, including increased security against vote tampering, real-time result tracking, and automatic execution of decisions based on voting outcomes. The use of blockchain technology may ensure that all votes are verifiable and that the voting process is transparent to all members of the cooperative.

Embodiments of the present invention may include methods for distributing and managing property tokens within digital wallets. These methods may be performed by components of the tokenized asset creation system 300, either as part of the method 200 of FIG. 2A or after its conclusion.

In some aspects, the system 300 may distribute the plurality of property tokens to respective digital wallets of the plurality of members of the cooperative. This distribution process may be carried out by the smart contract implementation component 324 of the dual ownership structure module 318. The smart contract may automate the token distribution based on predefined rules and conditions.

In some cases, the distribution of property tokens may be based on investment contributions from the plurality of members. For example, members who have made larger financial contributions to the cooperative or to a specific asset acquisition may receive a proportionally larger number of property tokens in their digital wallets. This approach may allow for a fair representation of each member's stake in the tokenized asset.

The system 300 may also include mechanisms for handling situations where a member loses access to their digital wallet. In such cases, the system may implement a recovery process that involves several steps. First, the system may receive authorization to burn the affected tokens. This authorization may come from a designated authority within the cooperative, such as the Secretary.

Upon receiving the authorization, the system may proceed to burn the inaccessible tokens. In the context of blockchain technology, “burning” tokens typically means permanently removing them from circulation by sending them to an unspendable address. This process may be executed by the smart contract implementation component 324.

After the burning process is complete, the system may issue equivalent replacement tokens to a new wallet for the member. These replacement tokens may have the same value and cost basis as the burned tokens, ensuring that the member does not lose their stake in the cooperative or the tokenized asset. The NFT issuance component 308 may be responsible for generating and distributing these replacement tokens.

It is important to note that the replacement tokens may have the same voting rights as the original burned tokens. This ensures that the member's participation in cooperative decision-making is not affected by the wallet recovery process.

By implementing these methods, the system 300 may provide a robust and flexible approach to managing property tokens within the cooperative structure. These processes may enhance the security and recoverability of members' digital assets, while maintaining the integrity of the token-based ownership and governance system.

Embodiments of the present invention may include methods for enabling wallet-to-wallet transfer of property tokens between members of the cooperative via blockchain transactions. This functionality may allow cooperative members to directly exchange their fractional ownership stakes in tokenized assets. In some aspects, the system 300 may implement a transfer mechanism within the smart contract that allows property token holders to initiate transfers to other members' wallets. The smart contract may verify the membership status of both the sender and recipient through their respective membership non-fungible tokens before executing the transfer.

The transfer process may involve several steps. First, a member initiating a transfer may submit a transfer request through their digital wallet interface. The smart contract may then validate the request, checking factors such as the sender's token balance and the recipient's eligibility to receive tokens. If all conditions are met, the smart contract may execute the transfer, moving the specified number of property tokens from the sender's wallet to the recipient's wallet.

These transfers may be recorded as blockchain transactions, ensuring transparency and immutability of ownership records. The smart contract may automatically update internal ownership records to reflect the new token distribution after each transfer.

In some implementations, the system may impose certain restrictions on transfers, such as minimum holding periods or maximum transfer amounts, to maintain stability within the cooperative structure. These rules may be encoded within the smart contract and automatically enforced during transfer attempts.

By enabling direct wallet-to-wallet transfers, the system may provide cooperative members with increased liquidity and flexibility in managing their tokenized asset holdings, while maintaining the security and transparency benefits of blockchain technology.

The wallet-to-wallet transfer process may include two verification steps. First, the system may verify the membership status of the transferring parties through their membership non-fungible tokens. This verification ensures that only legitimate cooperative members can participate in token transfers, maintaining the closed ecosystem of the cooperative and preventing unauthorized access to ownership rights. The membership verification may involve checking the validity and current status of the membership NFTs associated with both the sending and receiving wallets. Second, the system may record these transfers through smart contract execution. When a transfer is initiated, the smart contract not only moves the tokens between wallets but also creates an immutable record of the transaction on the blockchain. This record may include details such as the wallet addresses involved, the number of tokens transferred, the timestamp of the transaction, and verification status information. The dual verification and recording process provides a robust mechanism for maintaining the integrity of ownership records while facilitating peer-to-peer transfers within the cooperative framework.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

The system 300 may execute one or more blockchain-based distribution mechanisms, such as to manage dividends and/or ownership records for property token holders. The smart contract implementation component 324 may automate the process of distributing dividends to members who hold property tokens. This may involve calculating dividend amounts based on the number of tokens held and transferring the appropriate funds to each member's wallet. The smart contract may also maintain up-to-date ownership records, automatically updating them after each token transfer or dividend distribution. This blockchain-based approach may provide transparency and efficiency in managing financial distributions and ownership information within the cooperative.

Additionally, the system 300 may leverage the different token types to enable various functions within the cooperative. The membership non-fungible tokens issued by the NFT issuance component 308 may serve as the basis for a blockchain-based voting system. This system may allow cooperative members to participate in decision-making processes securely and transparently. The property ownership non-fungible token generated by the property NFT generation component 322 may establish and represent digital ownership rights for the tokenized asset. This token may serve as a digital certificate of ownership, potentially simplifying asset management and transfer processes. The property tokens created through the smart contract implementation component 324 may facilitate the automated distribution of ownership benefits. These benefits may include not only dividends but also other rights or privileges associated with asset ownership, such as access to certain facilities or services.

By implementing these features, the system 300 may create a comprehensive digital ecosystem for managing tokenized assets within the cooperative structure. This approach may combine the benefits of blockchain technology, such as transparency and automation, with traditional cooperative principles, potentially resulting in a more efficient and user-friendly system for fractional asset ownership and management.

Embodiments of the present invention may implement a property token exchange method to enable members of a cooperative to list and sell their property tokens. These property tokens represent fractional ownership in a tokenized asset, which may have been created using the method 200 shown in FIG. 2A or through other means.

In this exchange method, a member of the cooperative may submit a request to list their property tokens for sale on a dedicated exchange platform. Once the tokens are listed, the exchange system may facilitate the sale process. When a sale occurs, the exchange system may execute the transfer of the sold property tokens. This transfer may take place directly between the digital wallets of the buyer and seller, utilizing blockchain technology to ensure secure and transparent transactions.

The use of blockchain for these transfers may provide several benefits. It may create an immutable record of each transaction, allow for real-time settlement, and potentially reduce the need for intermediaries in the exchange process. This exchange method may offer cooperative members a way to liquidate their ownership stakes or adjust their investment in tokenized assets. It may also provide an opportunity for other members or new investors to acquire property tokens, potentially increasing the liquidity and accessibility of these fractional ownership investments.

Embodiments of the present invention may be applicable to various types of associations beyond cooperatives. While the term “cooperative” is used throughout this disclosure, the methods and systems described may be adapted for use with other organizational structures. These may include, but are not limited to, partnerships, corporations, limited liability companies (LLCs), joint ventures, and non-profit organizations.

In a partnership context, for example, the members may be referred to as “partners.” The tokenization process may represent partnership interests, with property tokens potentially corresponding to capital contributions or profit-sharing ratios. Similarly, in a corporation, members may be called “shareholders,” and the tokenized assets may represent shares of stock or other equity interests.

For LLCs, members may retain the designation of “member,” but the tokenization process may represent membership units or interests in the company. In a joint venture, participants might be called “venturers” or “co-venturers,” with tokens potentially representing their respective stakes in specific projects or overall venture interests.

Non-profit organizations may adapt this system for their “associates,” “supporters,” or “contributors.” In this context, tokens may represent voting rights, levels of involvement, or access to certain organizational benefits rather than ownership stakes.

Other examples may include investment clubs where members are “investors,” homeowners' associations with “residents” or “homeowners,” and professional associations with “affiliates” or “fellows.” In each case, the tokenization process may be tailored to represent the specific rights, responsibilities, and benefits associated with membership in that particular type of organization.

These examples illustrate how the principles outlined in this disclosure may be applied across a wide range of organizational structures, each with its own terminology and membership dynamics. The flexibility of the tokenization process allows for customization to suit the specific needs and characteristics of various types of associations.

### Membership, Property Ownership, and Fractionalized Property Tokens

The membership non-fungible tokens and property ownership non-fungible tokens described herein may take various forms beyond traditional non-fungible tokens (NFTs). In some implementations, the system may utilize alternative token structures or digital representations to signify membership status within the cooperative or similar organizational structure, as well as to represent ownership of the underlying asset.

For example, the membership tokens and property ownership tokens may be implemented as fungible tokens, such as ERC-20 tokens on the Ethereum blockchain. In this case, each member may receive a specific number of tokens representing their membership status, with the total supply of tokens corresponding to the total number of members in the organization. Similarly, property ownership may be represented by fungible tokens that correspond to the underlying asset. In other aspects, the system may employ a combination of fungible and non-fungible tokens to represent both membership and property ownership. This hybrid approach may involve issuing a fungible token to represent basic membership status, while additional non-fungible tokens may be used to denote specific roles, privileges, or achievements within the organization. For property ownership, a hybrid approach might use fungible tokens to represent fractional ownership while a non-fungible token represents the overall asset.

The membership tokens and property ownership tokens may take the form of verifiable credentials, which are cryptographically signed digital attestations. These credentials may contain membership information or property ownership details and can be stored in digital wallets, allowing for easy verification of membership status or ownership rights without necessarily being tied to a specific blockchain. In some implementations, the system may use decentralized identifiers (DIDs) to represent both membership and property ownership. DIDs are unique identifiers that enable verifiable, decentralized digital identity, and may be associated with cryptographic keys and service endpoints, providing a flexible way to manage membership identity and property ownership rights. Another approach may involve using soulbound tokens (SBTs), which are non-transferable tokens that represent traits, characteristics, or achievements of an individual. In the context of membership, an SBT may be issued to each member, representing their unique status within the organization. For property ownership, SBTs could represent permanent or non-transferable aspects of ownership rights. The system may implement a points-based membership system, where members accumulate digital points that represent their membership status, level, or privileges. Similarly, property ownership could be represented through a points-based system reflecting ownership stakes. These points may be recorded on a blockchain or other distributed ledger for transparency and security. In some cases, the membership tokens and property ownership tokens may take the form of digital badges or certificates, which can be cryptographically signed and verified. These digital assets may be displayed in member profiles or digital wallets, serving as visual representations of membership status or property ownership. The membership and property ownership representation may be implemented through a smart contract-based registry, where member information and property ownership details are stored directly in the contract state rather than as separate tokens. In this approach, membership status and ownership rights can be queried and verified by interacting with the smart contract.

These various forms of membership and property ownership representation may be used individually or in combination, depending on the specific needs and technical requirements of the organization implementing the system. The flexibility in token design and implementation allows for customization to suit different organizational structures, regulatory environments, and management needs for both membership and property ownership rights.

The various features and implementations described for membership and property ownership tokens may also be applicable to the plurality of property tokens representing fractional ownership in the tokenized asset. For example, the property tokens may be implemented as fungible tokens, such as ERC-20 tokens, allowing for easy divisibility and transfer of fractional ownership. The system may also employ a hybrid approach, combining fungible tokens for fractional ownership with non-fungible tokens for unique asset characteristics. These various approaches to implementing property tokens may be used individually or in combination, offering flexibility in designing fractional ownership structures that meet specific organizational needs and regulatory requirements.

The legal entity established for ownership of the asset may take various forms depending on the specific requirements, jurisdictional considerations, and operational needs of the cooperative or organization implementing the tokenized asset system. This legal entity may serve as a link between the traditional legal framework and the blockchain-based tokenization process, potentially providing a foundation for the dual ownership structure.

In some implementations, the legal entity may be structured as a Special Purpose Vehicle (SPV). An SPV may be designed to hold and manage the specific asset or group of assets being tokenized. This structure may offer benefits such as isolating the asset from other organizational activities and potentially providing tax advantages or liability protection. The legal entity may take the form of a trust. In this arrangement, the trust may hold the asset on behalf of the token holders, with the trustee managing the asset according to the terms specified in the trust agreement. This structure may be particularly useful in jurisdictions with well-established trust laws and may provide additional layers of asset protection and confidentiality. In some cases, the legal entity may be established as a Limited Liability Company (LLC). An LLC structure may offer flexibility in management and taxation while providing liability protection for its members. This form may be well-suited for situations where the asset requires active management or where pass-through taxation is desirable. Another form for the legal entity is a corporation, either as a C-corporation or an S-corporation depending on tax considerations and the number of investors involved. A corporate structure may provide a familiar legal framework for larger-scale operations and may be advantageous in certain regulatory environments.

In some jurisdictions, the legal entity may take the form of a foundation or a non-profit organization. This structure may be particularly relevant for assets with cultural, educational, or charitable significance, allowing for the integration of social or environmental goals into the asset management process. The legal entity may be structured as a Limited Partnership (LP) or a Limited Liability Partnership (LLP), which may be suitable for certain types of investment arrangements or professional services related to the asset. In some implementations, the legal entity may be a cooperative itself, mirroring the structure of the larger organization. This approach may align the legal ownership structure closely with the principles and governance models of cooperative organizations. For international or cross-border asset ownership, the legal entity may be established as an International Business Company (IBC) or a similar offshore structure, potentially offering tax efficiency and flexibility in global operations. In certain cases, the legal entity may take the form of a Real Estate Investment Trust (REIT) for real estate assets, providing a structure specifically designed for property ownership and management.

These various forms of legal entities may be selected based on factors such as the nature of the asset, the regulatory environment, tax considerations, management requirements, and the specific goals of the tokenization project. The choice of legal entity may impact aspects such as governance, liability protection, tax treatment, and the ability to operate in different jurisdictions. In some implementations, hybrid structures combining elements of different entity types may be used to tailor the legal framework to the specific needs of the tokenized asset and its stakeholders.

The smart contract implemented in the tokenized asset system may take various forms and incorporate different features depending on the specific requirements of the organization and the nature of the tokenized asset. In some implementations, the smart contract may be designed as a modular system, with separate components handling different aspects of the tokenization process. This approach may allow for greater flexibility and easier upgrades of individual functionalities.

The smart contract may be implemented using various technical standards and protocols, depending on the chosen blockchain platform and specific requirements. For example, Ethereum-based smart contracts may utilize standards such as ERC-20 for fungible tokens, ERC-721 for non-fungible tokens, or ERC-1155 for multi-token contracts. Other blockchain platforms like Binance Smart Chain may use BEP-20 or BEP-721 standards. The smart contract may be written in a language such as Solidity, Vyper, or Rust, depending on the blockchain ecosystem. Implementation may also involve using development frameworks like Truffle, Hardhat, or OpenZeppelin for enhanced security and standardization. In some cases, the smart contract may incorporate cross-chain interoperability protocols like Polkadot or Cosmos to enable asset transfer across different blockchain networks. Additionally, the contract may utilize oracle services like Chainlink for accessing off-chain data, or layer-2 scaling solutions such as Optimistic Rollups or zk-Rollups to improve transaction throughput and reduce costs.

The smart contract may incorporate advanced governance mechanisms, potentially including on-chain voting systems for token holders to participate in decision-making processes. These governance features may allow for decentralized management of the tokenized asset, with token holders having the ability to propose and vote on changes to the asset's management or distribution of benefits.

In some cases, the smart contract may include automated compliance checks to ensure that token transfers and other operations adhere to relevant regulations. This may involve integrating with external data sources or oracles to verify investor accreditation status or other compliance requirements.

The smart contract may also implement various economic models for distributing benefits or revenues generated by the tokenized asset. This could include dividend distribution mechanisms, revenue-sharing algorithms, or even more complex tokenomics models that incentivize certain behaviors or long-term holding.

In some implementations, the smart contract may incorporate interoperability features, allowing it to interact with other blockchain networks or decentralized finance (DeFi) protocols. This interoperability may enable cross-chain asset management or the integration of the tokenized asset into wider DeFi ecosystems.

The smart contract may include advanced security features such as multi-signature requirements for certain operations, time-locks for major changes, or circuit breakers to pause operations in case of detected anomalies. These security measures may help protect against potential vulnerabilities or attacks.

In some aspects, the smart contract may implement a layered or proxy architecture, allowing for upgradability of the contract logic while maintaining a consistent address for user interactions. This approach may provide flexibility for future improvements or adaptations to changing regulatory requirements.

The smart contract may also incorporate features for managing the lifecycle of the tokenized asset, including provisions for asset revaluation, fractional ownership adjustments, or even the eventual dissolution or tokenized asset.

In some implementations, the smart contract may include mechanisms for handling disputes or arbitration between token holders or between token holders and the asset management entity. This could involve on-chain dispute resolution processes or integration with off-chain legal frameworks.

The smart contract may also implement various data management and privacy features, potentially including zero-knowledge proofs or other cryptographic techniques to allow for verification of certain information without revealing sensitive details.

These various forms and features of the smart contract may be combined and customized to create a tailored solution that meets the specific needs of the tokenized asset and its stakeholders. The flexibility and programmability of smart contracts allow for a wide range of implementations, each designed to address particular requirements, regulatory considerations, and operational goals of the tokenization project.

In some implementations, the method 200 for creating a tokenized asset may be applied to any kind of asset, such as a car or building, enabling cooperative ownership among multiple members. This implementation may involve a distributed computer system comprising multiple interconnected devices communicating over a computer network.

For example, consider a scenario where a group of individuals wishes to collectively purchase and own a vacation home. The tokenized asset creation system may be implemented as follows:
Blockchain Network: A public distributed blockchain network forms the core of the system, hosting smart contracts, tokens, and transaction records. This decentralized network maintains the blockchain, validating and recording all transactions related to the tokenized asset.
Supporting Infrastructure: While core tokenization functionality resides on the blockchain, supporting systems facilitate user interactions and complex operations. These may include any one or more of the following:
   Application Servers: Distributed servers running specialized software to interface with the blockchain network, manage user requests, and coordinate with external systems. These servers may host components such as the membership module 302, asset acquisition module 310, and dual ownership structure module 318.
   Member Devices: Each cooperative member may interact with the system through a personal device such as a smartphone or desktop computer. These devices may run a dedicated application or use a web interface to connect to the blockchain network and supporting infrastructure.
   Legal Entity Management System: A separate computer system or a module within the supporting infrastructure may manage the legal aspects of asset ownership, interfacing with the blockchain system to ensure synchronization between digital and legal ownership records.

The process of tokenizing the vacation home may proceed as follows:
Membership Issuance: Prospective members may submit applications to the central server through their respective personal devices. The central server processes these applications, performs KYC verification (potentially interfacing with external identity verification services), and issues membership NFTs to approved members. These NFTs may be stored in digital wallets on the members' devices.
Asset Acquisition: Members may submit proposals to acquire the vacation home through their devices. The voting system 314 on the central server may then facilitate a blockchain-based vote, with members using their devices to cast votes securely.
Dual Ownership Structure Creation: Upon approval, the central server may initiate the process of creating the dual ownership structure. It may interface with the legal entity management system to establish the legal entity, while simultaneously generating the property ownership NFT on the blockchain.
Property Token Issuance: The smart contract implementation component 324 on the central server may create and distribute property tokens to members' digital wallets based on their respective investments.
Ongoing Management: Members may use their devices to view their ownership stakes, participate in decisions regarding the property, and potentially transfer their tokens to other members. The central server may manage these operations, updating both the blockchain and the legal ownership records as necessary.

This implementation may leverage various technologies to ensure security and efficiency:
Encryption: All communications between member devices and the central server may be encrypted to protect sensitive data.
Distributed Ledger Technology: The blockchain network may ensure transparent and immutable record-keeping of all transactions and ownership changes.
Smart Contracts: Automated scripts on the blockchain may manage token distributions, voting processes, and ownership transfers without manual intervention.
API Integrations: The system may integrate with external services for identity verification, property valuation, and legal documentation through secure APIs.

By implementing the tokenized asset creation method in this manner, the system may provide a user-friendly, secure, and efficient way for multiple individuals to collectively own and manage high-value assets like real estate.

To address the network communications within the real-world tokenization application, we can add the following description to the Detailed Description section:

The tokenized asset creation system may involve various network communications between and among the different devices and components. These communications may occur over secure, encrypted channels using protocols such as HTTPS, WebSocket, or custom blockchain communication protocols. Here's an overview of some network communications that may take place:
Member Device to Central Server: Members' devices may send registration requests, KYC information, and membership applications to the central server; transmit asset acquisition proposals and voting decisions; request updates on token balances, ownership stakes, and transaction histories; and initiate transfer requests for property tokens.
Central Server to Member Device: The server may send confirmation of membership approval and NFT issuance; push notifications about new acquisition proposals, voting events, and results to member devices; transmit updated token balances and ownership information; and send transaction confirmations and receipts to member devices.
Central Server to Blockchain Network: The server may interact with the blockchain in various ways, including: broadcasting new transactions for token issuance, transfers, and smart contract deployments; submitting voting results and asset acquisition decisions for recording on the blockchain; querying the blockchain for current state information, such as token balances and ownership records.
Blockchain Network to Central Server: The network may send confirmations of transaction processing and block inclusions; It may provide responses to state queries, including current token distributions and smart contract states.
Central Server to Legal Entity Management System: The server may send requests to create or update legal entities corresponding to tokenized assets; It may transmit ownership changes that need to be reflected in legal records.
Legal Entity Management System to Central Server: This system may send confirmations of legal entity creation or updates; It may provide legal ownership records for synchronization with the blockchain state.
Member Device to Blockchain Network: In some implementations, member devices may directly interact with the blockchain network to verify transactions or query token balances.
Central Server to External Services: The server may communicate with external KYC providers to verify member identities; It may interact with property valuation services or real estate databases for asset pricing information.

These communications may be facilitated through various network protocols and APIs, such as any one or more of the following:
RESTful APIs may handle request-response interactions between member devices and the central server.
WebSocket connections may enable real-time updates and notifications.
Blockchain-specific protocols may manage interactions with the distributed ledger network.
Secure file transfer protocols may be used for transmitting larger documents or data sets.

To ensure security and data integrity, the system may implement any one or more of the following:
End-to-end encryption for communications.
Digital signatures to verify the authenticity of messages and transactions.
Rate limiting and access controls to prevent abuse or unauthorized access.
Redundancy and failover mechanisms to ensure system availability.

By implementing these network communications, the tokenized asset creation system may provide a robust, secure, and efficient platform for managing cooperative ownership of real-world assets. The interconnected nature of these communications enables seamless interaction between members, the central management system, the blockchain network, and associated legal entities, facilitating transparent and decentralized asset ownership and management.

In some implementations, the tokenized asset creation system may utilize multiple blockchain networks. This multi-blockchain approach may offer advantages such as increased scalability, improved interoperability, or the ability to leverage specific features of different blockchain platforms. For example, the system may use one blockchain for membership NFTs, another for property ownership NFTs, and a third for property tokens. Alternatively, different assets within the cooperative may be tokenized on separate blockchains based on factors such as asset type, geographical location, or regulatory requirements. The system may implement cross-chain communication protocols to ensure seamless interaction between these different blockchain networks, potentially using technologies such as atomic swaps, sidechains, or interoperability platforms. This multi-blockchain architecture may provide greater flexibility in managing diverse assets and accommodating various regulatory frameworks across different jurisdictions.

Embodiments of the present invention include features which are only possible and/or feasible to implement with the use of one or more computers, computer processors, and/or other elements of a computer system. Such features are either impossible or impractical to implement mentally and/or manually.

For example, the creation and management of tokenized assets using blockchain technology, as described herein, requires cryptographic operations and distributed consensus mechanisms that can only be practically implemented using computer systems. The creation and management of tokenized assets using blockchain technology, as described herein, requires cryptographic operations and distributed consensus mechanisms that can only be practically implemented using computer systems. These complex processes may include any one or more of the following, which are inherently computational in nature:
Cryptographic operations: The generation of secure digital signatures, hash functions, and encryption/decryption processes are fundamental to blockchain technology. These operations require high-speed mathematical calculations that are infeasible to perform manually or mentally.
Distributed consensus mechanisms: Blockchain networks rely on consensus algorithms such as Proof of Work (PoW) or Proof of Stake (PoS) to validate transactions and maintain the integrity of the ledger. These mechanisms involve complex computational tasks and coordination among multiple nodes in the network, which can only be achieved through computer systems.
Smart contract execution: The implementation and execution of smart contracts, as described herein for creating property tokens, require precise and automated interpretation of code. This process involves handling multiple conditions, state changes, and interactions that are too complex for manual execution.
Token management: The issuance, transfer, and tracking of non-fungible tokens (NFTs) and property tokens involve maintaining large-scale, real-time databases and executing numerous transactions simultaneously. Such operations are only feasible with computer systems capable of processing and storing vast amounts of data.
Blockchain maintenance: The continuous operation of a blockchain network, including block creation, validation, and propagation, requires constant computational power and network communication that can only be provided by computer systems.

These technical aspects of blockchain technology underscore the necessity of computer systems in implementing the tokenized asset creation and management methods used by embodiments of the present invention. The complexity, speed, and scale of operations required for these processes make them impractical, if not impossible, to implement without sophisticated computer hardware and software.

The generation and verification of non-fungible tokens (NFTs) for membership and property ownership involve sophisticated cryptographic algorithms that are beyond human computational capabilities. These cryptographic processes ensure the security, uniqueness, and authenticity of the tokens within the blockchain ecosystem. The algorithms used typically include complex mathematical operations such as elliptic curve cryptography for digital signatures and secure hash functions for generating unique token identifiers.

For example, the creation of an NFT involves generating a unique cryptographic hash that serves as the token's identifier. This process requires performing millions of mathematical operations per second to create a hash that is practically impossible to reverse-engineer or duplicate. Similarly, the verification of an NFT's authenticity involves validating digital signatures and checking the token's provenance on the blockchain, which requires rapid processing of cryptographic proofs across a distributed network.

Moreover, the implementation of standards like ERC-721 for non-fungible tokens involves intricate smart contract logic that must be executed with precision and speed across the blockchain network. This includes managing token metadata, handling ownership transfers, and maintaining the overall integrity of the token ecosystem. The computational requirements for these operations far exceed human capabilities, necessitating the use of powerful computer systems and specialized hardware.

The cryptographic security of these tokens also relies on the generation of truly random numbers and the management of public-private key pairs, processes that are fundamentally rooted in complex computational methods. These operations ensure that each token is uniquely identifiable and can be securely owned and transferred within the cooperative structure, providing a robust foundation for the digital representation of membership and property ownership rights.

Additionally, the implementation of smart contracts to create and manage property tokens representing fractional ownership demands precise and automated execution of predefined rules and conditions, which is only feasible through computer-based systems. For example, smart contracts must execute complex logic and calculations with absolute precision and consistency across a distributed network of nodes. This includes handling intricate ownership structures, dividend distributions, and transfer restrictions that may be based on multiple conditions or time-based rules. Manual execution of these operations would be prone to errors and inconsistencies, potentially compromising the integrity of the ownership system.

Furthermore, smart contracts may operate in real-time, processing transactions and updating token balances instantaneously as ownership changes occur. This level of responsiveness and concurrent processing can only be achieved through automated, computer-based systems. The contracts may also interact with various components of the blockchain ecosystem, such as wallets, exchanges, and other smart contracts, requiring seamless integration and communication protocols that are beyond human capabilities.

Security is another critical aspect that necessitates computer-based implementation. Smart contracts managing valuable assets must incorporate robust cryptographic mechanisms to protect against unauthorized access and tampering. This includes features like multi-signature approvals, time-locked transactions, and integration with secure key management systems. These security measures rely on complex cryptographic algorithms and protocols that can only be effectively implemented and executed by computer systems.

Moreover, smart contracts often need to handle large volumes of data and transactions, especially in systems with numerous token holders and frequent transfers. The ability to scale and maintain performance under high loads can only be met by powerful computing systems with optimized data structures and processing algorithms.

Lastly, the immutable nature of blockchain-based smart contracts demands rigorous testing and verification before deployment. Computer-based simulation and formal verification tools may be used to ensure that the contract behaves correctly under all possible scenarios, as errors or vulnerabilities cannot be easily corrected once the contract is deployed on the blockchain.

Furthermore, the blockchain-based voting and distribution mechanisms described herein necessitate secure, transparent, and immutable record-keeping at a scale and speed that is impossible to replicate manually. The wallet-to-wallet transfer of property tokens and the maintenance of ownership records through smart contracts also rely on complex cryptographic protocols and distributed ledger technology that are inherently computer-based operations.

Embodiments of the present invention significantly enhance the efficiency and security of fractional asset ownership and management by leveraging blockchain technology and smart contracts. Traditional methods of managing shared ownership often rely on centralized record-keeping systems and manual processes, which can be prone to errors, lack transparency, and have limited scalability. Embodiments of the present invention address these limitations by implementing a decentralized, automated system that provides real-time, immutable record-keeping and seamless transfer of ownership rights.

For example, the use of non-fungible tokens (NFTs) to represent membership and property ownership rights enables a level of digital asset management that was previously unattainable. These tokens, implemented using standards such as ERC-721, provide unique, verifiable digital representations of ownership that can be securely stored and transferred on a blockchain network. This approach not only enhances the security of ownership records but also enables new functionalities, such as blockchain-based voting systems that can automatically verify member eligibility based on token ownership.

Furthermore, the implementation of smart contracts to manage property tokens introduces a level of automation and precision in fractional ownership management that surpasses traditional methods. Smart contracts, such as those implementing the ERC-3643 standard for security tokens, can automatically execute complex ownership rules, distribute dividends, and manage transfers without the need for manual intervention. This not only reduces the potential for human error but also significantly increases the speed and efficiency of asset management operations.

The dual ownership structure created by combining a legal entity with a property ownership NFT represents a significant technical innovation that solves the challenge of bridging traditional legal frameworks with blockchain-based digital ownership systems. This architecture implements a novel synchronization mechanism between on-chain and off-chain ownership records that was previously unattainable. By establishing parallel digital and legal ownership structures that maintain perfect correspondence through cryptographic verification, the system creates a tamper-resistant, transparent record of ownership that simultaneously satisfies regulatory requirements and enables programmatic asset management. The property ownership NFT functions as a digital twin of the legal entity, with embedded metadata that cryptographically links to legal documentation through secure hash functions. This technical implementation enables automated compliance verification, reduces reconciliation errors between digital and legal records, and creates an immutable audit trail of ownership changes across both domains. The dual structure also enhances security through redundancy—compromise of either the digital or legal component alone is insufficient to claim ownership, as the system requires cryptographic proof of correspondence between both elements. Furthermore, the architecture enables complex ownership arrangements that would be prohibitively complex to implement through traditional means, such as time-bound fractional ownership with automated dividend distribution based on token holdings. This technical solution significantly reduces transaction costs, eliminates intermediaries, and enables near-instantaneous verification of ownership status that was impossible with previous systems.

In conclusion, embodiments of the present invention provide a comprehensive technical solution to the challenges of fractional asset ownership and management. By leveraging blockchain technology, smart contracts, and innovative token standards, these embodiments create a system that significantly enhances the security, efficiency, and functionality of cooperative ownership structures. This not only addresses the limitations of traditional methods but also opens up new possibilities for asset management and investment that were previously unattainable.

Embodiments of the present invention may include a method for operating a property token exchange to facilitate the trading of tokenized assets within a cooperative structure. This method may implement a series of sequential buying windows designed to promote progressive decentralization of ownership while maintaining a controlled and orderly market for property tokens.

The property token exchange method may begin with receiving a listing of property tokens for sale from a member of a cooperative. These property tokens may represent fractional ownership in a tokenized asset, which may have been created through a dual ownership structure comprising a legal entity and a property ownership non-fungible token, such as by using any of the techniques disclosed elsewhere herein (e.g., in connection with FIG. 2A and FIG. 3).

Upon receiving the listing, the method may implement a series of sequential buying windows (time periods), each providing access to different groups of potential buyers in a specific order. For example, the first window may provide exclusive access to non-holders of property tokens, potentially encouraging broader participation and ownership diversification within the cooperative.

Following the first (e.g., non-holder) access window, the method may open a second (e.g., regional) member access window. During this period, cooperative members within a specific geographic region related to the listed property tokens may have the opportunity to bid on any unsold tokens. This regional focus may allow for localized investment and potentially strengthen community ties to the tokenized asset.

If tokens remain unsold after the regional window, the method may then implement a third (e.g., global) member access window. This phase may allow all cooperative members, regardless of their location, to bid on the remaining listed property tokens. This global access may further promote liquidity and broader ownership distribution within the cooperative structure.

In some implementations, the method may include an additional fourth (e.g., institutional buyer) access window after the third (e.g., global member) access window. This fourth phase may allow approved institutional buyers, such as Real Estate Investment Trusts (REITs), private equity firms, or decentralized finance (DeFi) platforms, to participate in the token sale. The inclusion of institutional buyers may provide additional liquidity and potentially stabilize the market for property tokens.

Throughout the exchange process, the method may include provisions for token value and liquidity disclaimers. These disclaimers may state that the property tokens are not guaranteed to hold value at their initial valuation (e.g., $1 per token) and that liquidity is not guaranteed. Such disclaimers may help manage expectations and inform token holders of potential risks associated with their investment.

The method may also include mechanisms for executing transfers of sold property tokens between the wallets of buyers and sellers via blockchain technology. This blockchain-based transfer process may ensure secure, transparent, and efficient transactions while maintaining an immutable record of ownership changes.

In some cases, the property token exchange method may incorporate provisions for the dissolution of the tokenized asset. These provisions may include triggers for dissolution such as insolvency of the Special Purpose Vehicle (SPV) legal entity, illegality of the asset or ownership structure, or operational inability to continue managing the asset. Such provisions may provide a framework for orderly wind-down and distribution of asset value in case of unforeseen circumstances.

By implementing this structured approach to property token exchange, embodiments of the present invention may create a controlled yet accessible marketplace for fractional ownership in tokenized assets. The sequential buying windows may promote ownership diversification and community engagement, while the blockchain-based transfer mechanisms may ensure secure and efficient transactions. These features, combined with clear disclaimers and dissolution provisions, may contribute to a robust and transparent system for managing and trading tokenized assets within a cooperative framework.

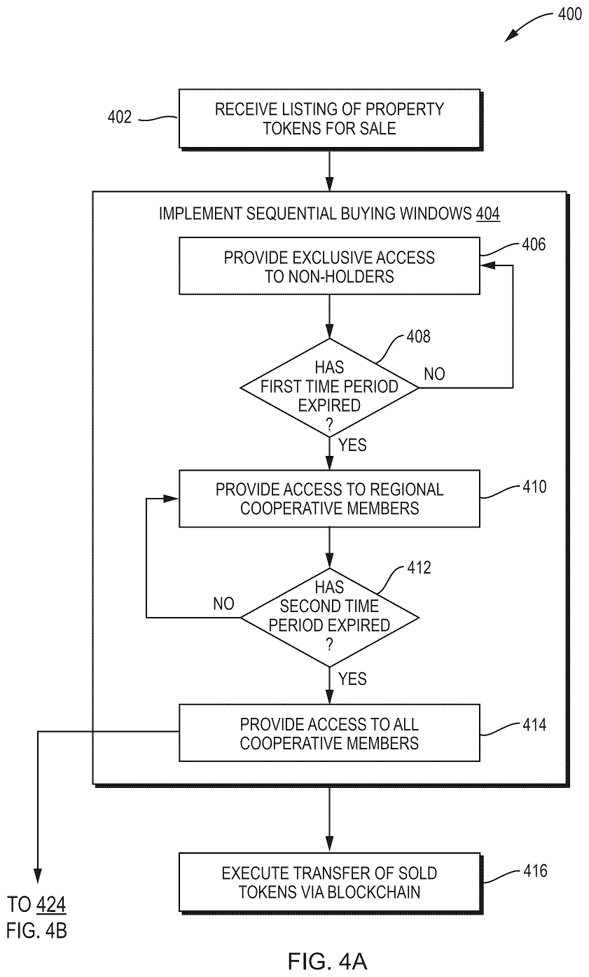

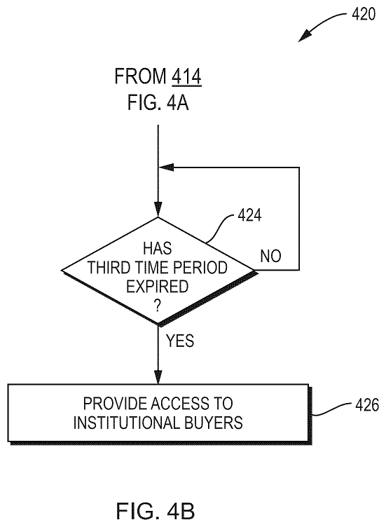

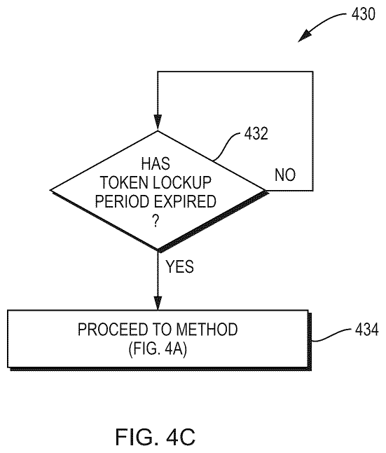

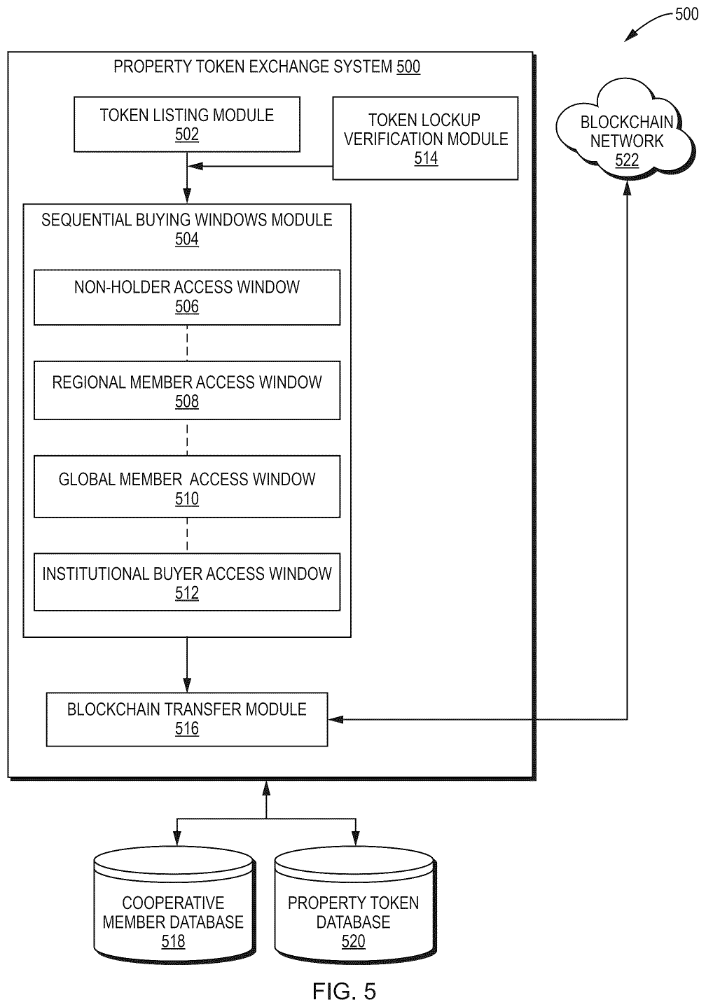

Referring to FIG. 4A, a flowchart is shown of a method 400 for implementing sequential buying windows for property tokens according to embodiments of the present invention. The method 400 may be performed by components of a property token exchange system 500 shown in FIG. 5.

The method 400 begins with a step 402 of receiving a listing of property tokens for sale. This step may be performed by a token listing module 502 of the property token exchange system 500. The listing may, for example, be received from a member of a cooperative or other association.

Following the receipt of the listing, the method 400 proceeds to a sequential windows process 404, which implements multiple buying windows (time periods). The sequential windows process 404 may establish a structured framework for controlling access to listed property tokens over time, with each window providing access to different groups of potential buyers in a predetermined sequence. This approach may allow embodiments of the present invention to manage token distribution in a controlled manner while progressively expanding the pool of eligible buyers. In some cases, the sequential windows process 404 may prioritize certain buyer categories during initial windows before broadening access in subsequent windows. This structured approach may promote various objectives, such as encouraging ownership diversification, maintaining community engagement, or ensuring fair access opportunities. The sequential nature of the process may also help maintain price stability by preventing market flooding, while the predefined time periods for each window may create clear expectations for all participants. By implementing the sequential windows process 404, embodiments of the present invention may balance competing interests such as liquidity provision, ownership distribution, and market stability within the cooperative framework. The sequential windows process 404 may be customized with different numbers, durations, and types of windows depending on specific cooperative goals, regulatory requirements, or asset characteristics.

Within process 404, a step 406 implements a first buying window which provides exclusive access to a first set of potential buyers. This first buying window may establish a controlled initial access period during which only specific categories of participants may bid on the listed property tokens. For example, step 406 may provide exclusive access to non-holders of property tokens, allowing cooperative members who do not currently own any property tokens to have the first opportunity to purchase the listed tokens. This step may be executed by a non-holder access window 506 of a sequential buying windows module 504.

In some cases, the non-holder access window 506 may include steps for verifying member status and non-holder status through blockchain. For example, the non-holder access window 506 may interact with a blockchain network 522 to verify that a potential buyer is a member of the cooperative but does not currently hold any property tokens. If verification succeeds, the method 400 enables bidding functionality for the potential buyer, allowing them to place bids on the listed property tokens during the non-holder access window. If verification fails (either because the potential buyer is not a cooperative member or because they already hold property tokens), the method 400 denies bidding access and may display an appropriate error message explaining the reason for the denial.

Following step 406, the method 400 moves to a decision step 408, which determines whether a first time period has expired. If the first time period has not expired, the method 400 returns to step 406. If the first time period has expired, the method 400 advances to a step 410, which implements a second buying window providing access to a second set of potential buyers. This second buying window may establish a controlled secondary access period during which a different category of potential buyers may bid on the listed property tokens. For example, step 410 may provide access to cooperative members within a specific regional geolocation related to the listed property tokens, allowing these regionally-associated members to have the next opportunity to purchase any unsold tokens. In some implementations, during this second buying window, access may be provided exclusively to the second set of potential buyers instead of the first set of potential buyers (e.g., non-holders). In alternative implementations, access during the second buying window may be provided to the second set of potential buyers in addition to the first set of potential buyers, such that both the first set of potential buyers and the second set of potential buyers have concurrent access to bid on the listed property tokens during the second buying window. This flexibility in access control allows the system to be configured according to specific cooperative policies or market conditions.

The step 410 may be executed by a regional member access window 508 of the sequential buying windows module 504. In some implementations, the regional member access window 508 may include steps for verifying member status and regional eligibility through blockchain. For example, the regional member access window 508 may interact with the blockchain network 522 to verify that a potential buyer is a member of the cooperative and is located within a specific geographic region related to the listed property tokens.

After step 410, the method 400 proceeds to a decision step 412, which determines whether a second time period has expired. If the second time period has not expired, the method 400 returns to step 410. If the second time period has expired, the method 400 advances to a step 414, which implements a third buying window providing access to a third set of potential buyers. This third buying window may establish a controlled tertiary access period during which a different category of potential buyers may bid on the listed property tokens. For example, step 414 may provide access to all cooperative members regardless of their geographic location, allowing these global members to have the next opportunity to purchase any unsold tokens. In some implementations, during this third buying window, access may be provided exclusively to the third set of potential buyers instead of the first or second sets of potential buyers (e.g., non-holders or regional members). In alternative implementations, access during the third buying window may be provided to the third set of potential buyers in addition to the first and second sets of potential buyers, such that all three sets of potential buyers have concurrent access to bid on the listed property tokens during the third buying window. This flexibility in access control allows the system to be configured according to specific cooperative policies or market conditions.

The step 414 may be performed by a global member access window 510 of the sequential buying windows module 504. In some cases, the global member access window 510 may include steps for verifying only member status through blockchain. For example, the global member access window 510 may interact with the blockchain network 522 to verify that a potential buyer is a member of the cooperative, regardless of their geographic location.

The method 400 concludes with a step 416, where the transfer of sold tokens is executed via blockchain. The term “sold tokens” refers to those property tokens from the original listing in step 402 that have been successfully purchased by buyers during any of the sequential buying windows implemented in process 404. These may include tokens purchased by non-holders during the first buying window (step 406), by regional cooperative members during the second buying window (step 410), or by global cooperative members during the third buying window (step 414). The blockchain transfer ensures secure and transparent recording of ownership changes for these successfully sold property tokens. This step may be carried out by a blockchain transfer module 516 of the property token exchange system 500.

In some implementations, the property token exchange system 500 may include a token lockup verification module 514 that verifies expiration of a token lockup period before implementing the sequential buying windows. This verification may occur before the sequential windows process 404 begins, ensuring that tokens are eligible for trading.

By implementing this structured approach to property token exchange, embodiments of the present invention may create a controlled yet accessible marketplace for fractional ownership in tokenized assets. The sequential buying windows may promote ownership diversification and community engagement, while the blockchain-based transfer mechanisms may ensure secure and efficient transactions.

Referring to FIG. 4B, a flowchart is shown of a method 420 for providing access to a fourth set of potential buyers (e.g., institutional buyers) after previous buying windows have concluded according to embodiments of the present invention. The method 420 may be performed by components of the property token exchange system 500 shown in FIG. 5.

The method 420 begins with a step 424, which presents a decision point asking whether a previous time period (e.g., the third time period of the method 400 of FIG. 4) has expired. This step 424 may correspond to the conclusion of the global member access window 510 in the sequential windows process 404 of method 400 (FIG. 4A). If the previous (e.g., third) time period has not expired, the method 420 returns to continue providing access to cooperative members. If the third time period has expired, the method 420 proceeds to a step 426.

At the step 426, access is provided to a fourth set of potential buyers (e.g., institutional buyers), allowing them to bid on any unsold listed property tokens. This step may be executed by an institutional buyer access window 512 of the sequential buying windows module 504. The institutional buyer access window 512 may represent the final buying window in the sequential access structure implemented by the property token exchange system 500.

In some cases, the institutional buyer access window 512 may include steps for verifying institutional buyer status through the blockchain network 522. For example, the institutional buyer access window 512 may interact with the blockchain network 522 to verify that a potential buyer is an approved institutional entity, such as a Real Estate Investment Trust (REIT), private equity firm, or decentralized finance (DeFi) platform.

The institutional buyer access window 512 may also include functionality for market makers to provide liquidity for overpriced tokens. In some implementations, the property token exchange system 500 may monitor listing prices relative to recommended thresholds. If the system detects that listed property tokens are priced above a recommended listing threshold, the institutional buyer access window 512 may enable approved institutional buyers to serve as market makers.

These institutional buyers serving as market makers may be entities such as REITs, private equity firms, or DeFi platforms. By allowing these entities to provide liquidity, the property token exchange system 500 may help maintain market stability and ensure that token holders have options for selling their tokens even when individual buyers may be less likely to purchase due to higher prices.

After the institutional buyer access window 512 concludes, any transfers of sold tokens may be executed via the blockchain transfer module 516, similar to the process described in step 416 of method 400 (FIG. 4A).

By implementing this additional access window for institutional buyers, embodiments of the present invention may provide enhanced liquidity and market stability for the property token exchange, while maintaining a controlled and orderly progression of buying opportunities within the cooperative structure.

The property token exchange system 500 may implement various sale processes that utilize the bids received by the method 400 of FIG. 4A. These sale processes may be designed, for example, to accommodate different market conditions, cooperative policies, and asset types.

Embodiments of the present invention may implement various bidding process types across the different buyer access windows. Any of the non-holder access window 506, regional member access window 508, global member access window 510, and institutional buyer access window 512 may utilize any one or more of the following bidding mechanisms, in any combination. For example, a bidding process may implement an open auction format, where bids are visible to all participants and updated in real-time. Alternatively, a bidding process may use a sealed bid process, where bidders submit confidential offers. In other implementations, a bidding process may employ a fixed price sale, where tokens are sold at a predetermined value. Another option is a Dutch auction format, where the price starts high and gradually decreases until all tokens are sold. Different buyer access windows may use the same bidding process type or different bidding process types as each other. For instance, both the non-holder access window 506 and the global member access window 510 might use an open auction format, while the regional member access window 508 uses a sealed bid process and the institutional buyer access window 512 employs a Dutch auction format. The flexibility to mix and match bidding process types across different access windows allows the system to be optimized for various market conditions and participant preferences.

According to another aspect of the invention, the property token exchange system 500 may apply various criteria for determining winning bids. In some cases, the blockchain transfer module 516 may execute transfers based on the highest price offered for each token. Alternatively, the system may implement a first-come-first-served approach, where the earliest valid bids are prioritized. In other implementations, the system may consider a combination of factors, such as bid price, buyer reputation (which may be stored in the cooperative member database 518), and quantity of tokens requested.

In a further implementation, the property token exchange system 500 may include mechanisms for resolving ties or competing bids. For example, if multiple bidders offer the same price during the regional member access window 508, the system may prioritize bids based on the bidder's proximity to the asset associated with the tokens. In other cases, the system may implement a time-based tiebreaker, where the earlier bid is given preference. During the institutional buyer access window 512, ties may be resolved by allocating tokens proportionally among competing institutional buyers.

Embodiments of the present invention may also include various methods for winner notification and token transfer execution. In some implementations, the blockchain transfer module 516 may automatically notify winning bidders through a secure messaging system integrated with the property token exchange system 500. The system may then initiate a smart contract to execute the transfer of tokens from the seller's wallet to the buyer's wallet on the blockchain network 522. In other cases, winners may be required to confirm their purchase within a specified timeframe before the transfer is executed.

The property token exchange system 500 may implement bid amount limitations to ensure fair participation and prevent market manipulation. For instance, during the non-holder access window 506, the system may cap the maximum number of tokens that can be purchased by a single bidder. In the regional member access window 508, minimum bid amounts may be set to ensure serious participation. The global member access window 510 may implement dynamic bid limits that adjust based on the number of remaining tokens and the number of active bidders.

In some embodiments, the sequential buying windows module 504 may enforce time constraints for bid submission and resolution. For example, the non-holder access window 506 may allow bid submissions for a fixed duration, after which no new bids are accepted. The regional member access window 508 may implement a “soft close” mechanism, where the window extends if a new bid is placed near the closing time. In the global member access window 510, the system may resolve bids in batches at predetermined intervals. The institutional buyer access window 512 may operate on a continuous basis until all tokens are sold or a predefined end date is reached.

According to another aspect of the invention, the property token exchange system 500 may incorporate different pricing models within the bidding process. In some implementations, the non-holder access window 506 may use a uniform pricing model, where all winning bidders pay the same price, determined by the lowest successful bid. The regional member access window 508 may implement a discriminatory pricing model, where each winning bidder pays their bid price. In other cases, the global member access window 510 may employ a reference pricing model, where bids are evaluated against a hidden reserve price.

Embodiments of the present invention may also include mechanisms for handling partial fills of bids. For instance, if a bidder in the institutional buyer access window 512 requests more tokens than are available, the system may allocate the available tokens and place the remainder of the bid on a waitlist. In some implementations, the property token exchange system 500 may allow bidders to specify whether they are willing to accept partial fills or only complete fills of their bids.

In a further implementation, the property token exchange system 500 may incorporate conditional bidding options. For example, during the regional member access window 508, bidders may be allowed to place contingent bids that are only activated if certain conditions are met, such as a minimum number of tokens being available or a maximum price threshold. The global member access window 510 may support package bidding, where bidders can submit bids for combinations of different token types with the condition that the bid is only valid if all components are won.

Referring to FIG. 4C, a flowchart is shown of a method 430 for verifying token lockup period expiration before implementing sequential buying windows according to embodiments of the present invention. The method 430 may be performed by components of the property token exchange system 500 shown in FIG. 5, particularly the token lockup verification module 514. The method 430 of FIG. 4C may, for example, be performed before the method 400 of FIG. 4A.

The method 430 includes a decision step 432 that determines whether a token lockup period has expired. This verification step may be crucial for ensuring that property tokens are eligible for trading on the exchange. In some cases, the token lockup period may be implemented as part of the initial tokenization process to maintain stability in token ownership during the early stages of the asset's lifecycle. For example, real estate property tokens might have a 12-month lockup period to allow for property stabilization and initial rental income establishment. Vehicle asset tokens could implement a 6-month lockup period to align with initial depreciation calculations. Business asset tokens might use an 18-month lockup period to coincide with early operational milestones or revenue targets. Infrastructure project tokens could have phased lockup periods, with 25% of tokens becoming tradeable every 3 months over a one-year period. For loan-backed tokens, the lockup period might correspond to the first interest payment cycle, typically 3-6 months. Additionally, tokens representing newly constructed properties might have lockup periods tied to construction completion plus 90 days to ensure all building systems are functioning properly before trading begins.

The token lockup verification module 514 may interact with the property token database 520 to check the issuance date and lockup duration for the specific tokens being listed for sale. This verification process may involve querying smart contract data on the blockchain network 522 to ensure the accuracy and immutability of the lockup information.

If the token lockup period has not expired (No branch from decision step 432), the method 430 may return to continue checking the lockup period status. This continuous checking may be implemented as a periodic process or triggered by specific events, such as attempts to list tokens for sale.

If the token lockup period has expired (Yes branch from decision step 432), the method 430 proceeds to a step 434. At step 434, the method 430 may initiate the sequential windows process 404 of method 400, as illustrated in FIG. 4A. This connection indicates that the token lockup period verification serves as a prerequisite check before initiating the sequential buying windows process.

In some implementations, the token lockup verification module 514 may provide additional functionalities beyond simple expiration checks. For example, the module may:
Calculate and display the remaining lockup time for tokens that are still within their lockup period.
Notify token holders when their lockup period is approaching expiration, allowing them to prepare for potential trading activities.
Implement graduated lockup releases, where a portion of tokens becomes available for trading at different time intervals.
Integrate with the smart contract implementation to automatically update token status from “locked” to “tradeable” upon expiration of the lockup period.
Provide an interface for authorized administrators to modify lockup periods in response to changing market conditions or regulatory requirements.

By implementing this token lockup verification process, embodiments of the present invention may ensure that only eligible tokens enter the trading ecosystem, maintaining the integrity of the property token exchange and potentially reducing the risk of market manipulation or instability.

The token lockup verification process may be particularly relevant for various types of tokenized assets. For example, when the asset comprises real property, such as a building, the lockup period may align with important milestones in property development or stabilization. In cases where the asset is an automobile, the lockup period may correspond to initial depreciation periods or leasing terms. For assets such as loans or energy infrastructure, the lockup period may be designed to match the maturation of the underlying financial instruments or the completion of critical project phases.

In some implementations, the token lockup verification module 514 may interface with other components of the property token exchange system 500 to enhance its functionality. For instance:
The module may communicate with the token listing module 502 to prevent premature listing attempts for tokens still within their lockup period.
It may interact with the blockchain transfer module 516 to ensure that only unlocked tokens can be transferred between wallets.
The module may provide data to the sequential buying windows module 504 to adjust window durations or participant eligibility based on the volume of newly unlocked tokens.
In cases where the asset is a business, the token lockup verification may be coordinated with corporate events or financial reporting periods to ensure fair and informed trading.

By integrating the token lockup verification process with these various components and considerations, embodiments of the present invention may create a robust and flexible system for managing the transition of property tokens from a locked state to active trading on the exchange.

The property token exchange system 500 may implement a blockchain transfer module 516 to execute and record transfers of property tokens between buyers and sellers. This module may interact with the blockchain network 522 to ensure secure and transparent transactions.

In some cases, the blockchain transfer module 516 may record specific details of each transfer. These details may include, for example, any one or more of the following: wallet addresses of the buyer and seller, the number of tokens transferred, a timestamp of the transaction, verification status information. By recording these details on the blockchain network 522, embodiments of the present invention may create an immutable and auditable record of all property token transfers within the cooperative structure.

The property token exchange system 500 may also integrate with a cooperative member database 518 and a property token database 520. These databases may store and manage information crucial to the operation of the exchange.

For example, the cooperative member database 518 may contain member profiles, including verification status, geographic location, and token holdings. This information may be used by the sequential buying windows module 504 to determine eligibility for participation in different buying windows.

The property token database 520 may store information about each tokenized asset, including details such as asset type, valuation, and token distribution. This database may be queried by the token listing module 502 when processing new listings and by the blockchain transfer module 516 when executing transfers.

Embodiments of the present invention may implement functionality for monitoring listing prices relative to recommended thresholds. The property token exchange system 500 may, for example, compare current listing prices to historical data, market trends, or predefined benchmarks stored in the property token database 520.

In some cases, if the system detects that listed property tokens are priced above a recommended listing threshold, the institutional buyer access window 512 may be activated. This window may enable approved institutional buyers, such as Real Estate Investment Trusts (REITs), private equity firms, or decentralized finance (DeFi) platforms, to provide liquidity by purchasing the listed property tokens.

The property token exchange system 500 may facilitate these institutional buyer purchases to maintain market liquidity for overpriced listings. For instance, the system may automatically notify eligible institutional buyers when overpriced listings are detected. The blockchain transfer module 516 may then prioritize the execution of these transactions to quickly address liquidity issues.

By implementing these features, embodiments of the present invention may create a robust and flexible property token exchange system. The integration of blockchain technology with traditional databases may enable secure, transparent, and efficient trading of tokenized assets while maintaining the integrity of the cooperative structure and ensuring market stability.

Embodiments of the present invention include methods for handling bid requests during the sequential buying windows implemented by the property token exchange system 500. These methods align with the steps of method 400 shown in FIG. 4A and are executed by components of the system 500 illustrated in FIG. 5.

In general, the bid request handling process involves receiving a bid request from a potential bidder during a specific buying window, verifying the bidder's eligibility based on criteria relevant to that window, enabling bidding functionality if verification is successful, receiving the bid request, and recording the bid request and verification results on the blockchain.

For the non-holder access window 506 (step 406 in FIG. 4A), the method may verify that the potential bidder is a cooperative member but does not currently hold any property tokens. This verification process may use the membership non-fungible token to confirm membership status and checks the bidder's token holdings.

During the regional member access window 508 (step 410 in FIG. 4A), the method may verify both cooperative membership and that the bidder's geolocation matches the regional geolocation of the listed property tokens. This ensures that only members within the specified region can participate in this buying window.

For the global member access window 510 (step 414 in FIG. 4A), the method may verify cooperative membership, allowing any member regardless of location to bid on remaining tokens.

In the institutional buyer access window 512, which may follow the global member access window, the method may verify that the potential buyer is an approved institutional entity, such as a REIT, private equity firm, or DeFi platform.

In all cases, upon successful verification, the system enables bidding functionality for the potential bidder and records the bid request and verification results via blockchain, ensuring a transparent and auditable process.

These methods leverage the cooperative member database 518 and the blockchain network 522 to perform verifications and record results, creating a secure and efficient bidding process tailored to each sequential buying window.

In some embodiments, the transfer of property tokens between buyers and sellers may be executed and recording on a blockchain-based exchange system. Such execution and transfer implements a transparent and verifiable process for transferring ownership of tokenized assets within a cooperative structure.

Such transfer of property tokens may, for example, include receiving confirmation of a successful bid on a listed property token. In response to receiving this confirmation, the system may verify the membership status of both the buyer and seller in the cooperative through their respective membership non-fungible tokens. The system may then execute a smart contract to transfer the listed property token from the seller's wallet to the buyer's wallet. As part of this process, details of the transfer may be recorded on the blockchain, and ownership records maintained through the smart contract may be updated accordingly.

The recorded details of the transfer may include various elements that enhance the transparency and traceability of each transaction. These details may, for example, include any one or more of the following: the wallet addresses of both the buyer and seller, the number of tokens transferred during the transaction, a timestamp indicating when the transaction occurred, and verification status information that confirms the legitimacy of the transfer.

This method may provide a comprehensive approach to managing property token transfers, ensuring that only verified members can participate in transactions, and maintaining a detailed, blockchain-based record of all transfers. The inclusion of specific transaction details in the blockchain record may enhance transparency and facilitate auditing or dispute resolution if needed.

Embodiments of the present invention may include methods for managing overpriced property token listings and facilitating market liquidity through institutional buyer involvement. These methods may address situations where listed property tokens exceed recommended pricing thresholds, potentially impacting market stability and liquidity.

In some implementations, the property token exchange system 500 may monitor and respond to pricing data indicating that listed property tokens are priced above a recommended listing threshold. Upon detecting such a situation, the system may initiate a process to identify and engage institutional buyers to serve as market makers, providing liquidity for these overpriced listings.

The process may begin with the property token exchange system 500 receiving pricing data that suggests one or more particular listed property tokens have exceeded a recommended pricing threshold. This data may be derived from various sources, such as market analysis tools, historical pricing information, or predefined benchmarks stored within the property token database 520.

In response to this pricing data, the system may activate mechanisms to address the potential liquidity issues. One such mechanism may involve identifying institutional buyers capable of serving as market makers for the overpriced listings. These institutional buyers may include entities such as Real Estate Investment Trusts (REITs), private equity firms, or decentralized finance (DeFi) platforms. The system may maintain a database of approved institutional buyers, potentially as part of the cooperative member database 518, and may select appropriate buyers based on factors such as their investment focus, available capital, or past performance in similar market-making roles.

Once suitable institutional buyers have been identified, the property token exchange system 500 may enable these buyers to provide liquidity by purchasing the listed property tokens. This may involve granting special access or permissions to these institutional buyers, potentially through the institutional buyer access window 512. The system may notify the selected institutional buyers of the overpriced listings and provide them with relevant details to facilitate their market-making activities.

To ensure transparency and maintain the integrity of the exchange, the property token exchange system 500 may record all market maker transactions via the blockchain network 522. This may involve using the blockchain transfer module 516 to execute and log these transactions, creating an immutable record of the institutional buyers' market-making activities.

In some implementations, the property token exchange system 500 may implement ongoing monitoring of listing prices relative to recommended thresholds. This continuous monitoring may allow the system to proactively identify listings that may require market maker liquidity based on their pricing. The system may employ various algorithms or analytical tools to compare current listing prices against historical trends, market averages, or predefined thresholds stored in the property token database 520.

Upon identifying listings that may benefit from market maker intervention, the property token exchange system 500 may facilitate institutional buyer purchases to maintain market liquidity for these overpriced listings. This facilitation may involve several steps, such as automatically notifying eligible institutional buyers of the opportunity, providing them with relevant market data, and potentially offering incentives for their participation in providing liquidity.

The blockchain transfer module 516 may play a crucial role in this process, potentially prioritizing the execution of these market-making transactions to quickly address liquidity issues. By leveraging the speed and transparency of blockchain technology, the system may be able to rapidly deploy institutional buyer liquidity where it is most needed, helping to stabilize the market for overpriced property tokens.

Through these mechanisms, embodiments of the present invention may provide a sophisticated approach to managing market liquidity and price stability within the property token exchange. By leveraging institutional buyers as market makers and utilizing blockchain technology for transparent record-keeping, the system may be able to address potential market imbalances efficiently and maintain a healthy trading environment for all participants.

Embodiments of the present invention may implement various types of wallets for buyers and sellers in the property token exchange system. These wallets may serve as digital containers for storing, managing, and transferring property tokens, as well as facilitating transactions within the cooperative structure.

In some cases, the wallets may be implemented as software-based digital wallets. These digital wallets may be accessible through web browsers, desktop applications, or mobile apps. The software-based wallets may interact with the blockchain network 522 to manage property tokens, execute transactions, and verify ownership. For example, a cooperative member may access their wallet through a secure web portal, allowing them to view their token balance, initiate transfers, and participate in buying windows.

Embodiments of the present invention may also utilize hardware wallets for enhanced security. Hardware wallets may be physical devices, such as USB drives or specialized electronic devices, that store the private keys necessary for accessing and transferring property tokens. These hardware wallets may provide an additional layer of security by keeping the private keys offline when not in use. In some implementations, the property token exchange system 500 may support integration with various types of hardware wallets, allowing users to securely store their tokens and sign transactions offline before broadcasting them to the blockchain network 522.

In some aspects, the wallets may be implemented as smart contract wallets. These wallets may be controlled by smart contracts deployed on the blockchain network 522, potentially offering advanced features such as multi-signature functionality, programmable transfer rules, or integration with decentralized finance (DeFi) protocols. Smart contract wallets may allow for more complex ownership structures or automated token management based on predefined conditions.

Embodiments of the present invention may incorporate custodial wallets managed by the cooperative or a trusted third party. In this implementation, the property token exchange system 500 may provide a custodial service where it manages the private keys on behalf of the users. This approach may simplify the user experience for members who are less familiar with blockchain technology, while still allowing them to participate in the token exchange.

In some cases, the wallets may be implemented as multi-signature wallets. These wallets may require multiple private key signatures to authorize transactions, potentially enhancing security and allowing for shared control of property tokens. For example, a multi-signature wallet may be used for tokens representing shared ownership of an asset, requiring approval from multiple parties before executing a transfer.

Embodiments of the present invention may support integration with decentralized identity (DID) wallets. These wallets may not only store property tokens but also manage the user's decentralized identity credentials. DID wallets may allow users to prove their membership status, regional eligibility, or other relevant attributes without revealing unnecessary personal information during the bidding process.

In some implementations, the wallets may take the form of non-custodial wallets where users have full control over their private keys. These wallets may provide users with complete ownership and responsibility for their property tokens, aligning with principles of decentralization and self-sovereignty. The property token exchange system 500 may offer tools and guidance to help users securely manage their non-custodial wallets.

In some aspects, the wallets may be implemented as browser extension wallets. These extensions may integrate directly with web browsers, allowing users to interact with the property token exchange system 500 seamlessly while browsing. Browser extension wallets may provide a balance between convenience and security, potentially incorporating features such as automatic network switching or transaction signing.

Embodiments of the present invention may support social recovery wallets. These wallets may implement a recovery mechanism where a user can regain access to their tokens through a network of trusted contacts. This approach may provide a safety net for users who lose access to their primary wallet, potentially increasing user confidence in participating in the property token exchange.

In some cases, the property token exchange system 500 may implement wallet abstraction layers. These layers may allow users to interact with the system using familiar authentication methods, such as email and password or biometrics, while the underlying wallet functionality is abstracted away. This approach may lower the barrier to entry for users unfamiliar with traditional cryptocurrency wallets.

By supporting various wallet implementations, embodiments of the present invention may provide flexibility and choice to users of the property token exchange system. This diversity in wallet options may cater to different user preferences, security requirements, and technical proficiencies, potentially enhancing the overall accessibility and adoption of the tokenized asset exchange platform.

Any plurality of wallets used by embodiments of the present invention may include one or more wallets of any of the kind(s) disclosed herein, in any combination.

Embodiments of the present invention may implement various types and durations of buying windows within the property token exchange system. The sequential buying windows shown in FIGS. 4A-4C and described elsewhere herein may be adapted and customized to suit different market conditions, asset types, or cooperative structures.

In some aspects, the buying windows may have fixed time durations. For example, the non-holder access window may last for 24 hours, the regional member access window for 48 hours, and the global member access window for 72 hours. In other implementations, the durations may be variable, with each window's length determined dynamically based on factors such as market activity, token demand, or asset characteristics.

The buying windows may, in some cases, be implemented as rolling windows that overlap with each other. For instance, the regional member access window may begin before the non-holder access window fully closes, allowing for a smoother transition between buyer groups and potentially increasing overall market liquidity.

In some implementations, the buying windows may be volume-based rather than time-based. For example, a window may close when a certain percentage of the listed tokens have been sold, or when the total transaction volume reaches a predetermined threshold.

The property token exchange system may, in some aspects, implement conditional buying windows that open or close based on specific market events or price movements. For instance, a special buying window may be triggered if the token price falls below a certain threshold, allowing for rapid price stabilization.

In some cases, the buying windows may be implemented with a gradual access model. Instead of abrupt transitions between windows, the system may gradually increase the number of eligible buyers over time, potentially reducing market volatility associated with sudden changes in buyer pool size.

The property token exchange system may, in some implementations, utilize auction-style buying windows. These windows may open with a set duration but extend automatically if new bids are placed near the closing time, similar to the overtime periods in online auctions.

In some aspects, the buying windows may be implemented with a priority queue system. While a window is open to all eligible buyers, those who joined the queue earlier may have their bids processed first, potentially incentivizing early participation.

The property token exchange system may, in some cases, implement buying windows with dynamic pricing mechanisms. The token price may adjust automatically based on demand during each window, potentially optimizing price discovery and market efficiency.

In some implementations, the buying windows may be customized based on the type of asset being tokenized. For example, real estate tokens may have longer buying windows to account for the typically slower pace of property transactions, while tokens representing more liquid assets may have shorter windows.

The expiration of buying windows may be determined through various methods. In some cases, a centralized time server may be used to track window durations and trigger transitions. In other implementations, the expiration may be determined through a decentralized consensus mechanism on the blockchain network.

The property token exchange system may, in some aspects, use smart contracts to manage buying window expirations. These contracts may automatically close one window and open the next based on predefined conditions, potentially reducing the need for manual intervention.

In some cases, the expiration of a buying window may be determined through a hybrid approach, combining on-chain and off-chain data. For example, the system may reference external time sources while also considering on-chain transaction volumes to determine when to close a window.

The property token exchange system may, in some implementations, allow for manual override of buying window expirations by authorized administrators. This feature may provide flexibility to adapt to unexpected market conditions or technical issues.

In some aspects, the expiration of buying windows may be determined through a voting mechanism. Token holders or cooperative members may vote to extend or close a window, potentially allowing for community-driven market management.

These various implementations of buying windows and expiration mechanisms may provide flexibility and customization options for the property token exchange system. By offering diverse approaches to structuring and managing buying windows, embodiments of the present invention may accommodate a wide range of tokenized assets and market scenarios.

Embodiments of the present invention include features of the property token exchange method (e.g., as shown in FIGS. 4A-4C and 5) which are only possible and/or feasible to implement with the use of one or more computers, computer processors, and/or other elements of a computer system. Such features are either impossible or impractical to implement mentally and/or manually. For example, the implementation of sequential buying windows for property tokens requires complex computational processes that can only be practically executed by computer systems. For example, the method may include computer-automated steps of determining whether each time period has expired and, in response to determining that the current time period has expired, automatically starting the next time period, including automatically providing bidding access to the set of potential buyers associated with that next time period. These automated transitions between time periods may include, for example, simultaneously managing multiple time-based access controls, verifying eligibility criteria through blockchain queries, processing concurrent bids across different user categories, and maintaining consistent state information throughout the sequential windows. Such steps may include real-time data processing, securing user authentication, and automated decision-making capabilities that far exceed human cognitive and manual capabilities, making computer implementation not merely preferable but essential for the functioning of the sequential buying windows system.

Embodiments of the present invention may include computer-implemented methods for providing exclusive bidding access to a particular set of buyers during a specific sequential buying window. These methods may leverage the capabilities of computer systems to manage complex, time-sensitive operations that would be impractical or impossible to execute manually. For example, during a particular buying window associated with a particular set of potential buyers, the property token exchange system 500 may electronically notify the particular set of potential buyers of their access to bid on the plurality of property tokens associated with the particular sequential buying window. This notification process may involve automated generation and distribution of personalized messages to eligible buyers. The system may, for instance, utilize the cooperative member database 518 to identify the specific set of buyers eligible for the current window, and then automatically send notifications through various electronic channels such as email, SMS, or in-app notifications. Such a process may require simultaneous communication with numerous users, precise timing coordination, and integration with multiple messaging platforms—tasks that are inherently suited to computer systems.

Additionally, the system may be configured to not process bid requests received from users who are not within the particular set of buyers associated with the particular sequential buying window. This filtering mechanism may involve real-time verification of each incoming bid request against the current eligibility criteria. For instance, during the non-holder access window 506, the system may automatically cross-reference incoming bid requests with token holding records in the property token database 520, automatically rejecting bids from users who already hold property tokens. This process may require continuous, high-speed data processing and decision-making that is beyond human capabilities, especially when dealing with a large volume of simultaneous bid requests.

The inherently computer-implemented nature of these steps is evident in several aspects. First, the system may need to manage multiple time-sensitive operations concurrently, such as tracking the expiration of the current buying window, verifying user eligibility, and processing bid requests. This level of multitasking and precise timing control is achievable only through computer systems. Second, the instant verification of user eligibility against complex criteria (e.g., token holdings, geographical location, institutional status) for each bid request requires rapid database queries and logic processing that human operators could not perform at the necessary speed and scale. Third, the system may need to maintain consistent state information across multiple components (e.g., the sequential buying windows module 504, the blockchain transfer module 516) to ensure that access controls are uniformly enforced throughout the bidding process. Such real-time synchronization across distributed system components is a hallmark of computer-implemented methods.

Furthermore, the integration of these processes with blockchain technology, as facilitated by the blockchain network 522, adds another layer of complexity that necessitates computer implementation. The system may need to interact with smart contracts, verify cryptographic signatures, and record transactions on the blockchain-operations that are fundamentally computational in nature and cannot be performed manually.

In some cases, the property token exchange system 500 may also implement security measures to prevent unauthorized access attempts during exclusive bidding windows. For example, the system may employ machine learning algorithms to detect and block suspicious patterns of bid requests that may indicate attempts to circumvent access controls. Such real-time threat detection and response mechanisms are inherently computer-based operations that rely on rapid data analysis and automated decision-making.

By leveraging these computer-implemented methods, embodiments of the present invention may provide a secure, efficient, and fair process for managing exclusive access during sequential buying windows in the property token exchange system. The automated nature of these processes may help ensure consistency, reduce human error, and enable the system to handle high volumes of users and transactions, potentially enhancing the overall effectiveness and reliability of the tokenized asset exchange.

Furthermore, the verification of membership status and token holdings through blockchain technology is a computationally intensive task that requires interfacing with distributed ledger systems. This process involves cryptographic operations, such as verifying digital signatures and hashing, which are infeasible to perform manually at the scale and speed required for a functional exchange system. The method also includes recording bid requests and verification results on the blockchain, which demands specialized hardware and software to interact with the blockchain network and execute smart contracts.

The execution of token transfers between wallets via blockchain is another feature that is only practical with computer systems. This process involves complex cryptographic operations, updating distributed ledgers across a network of nodes, and ensuring consensus-tasks that are beyond human computational abilities. Additionally, the system's ability to monitor token prices in real-time, identify overpriced listings, and facilitate market maker interventions requires continuous data analysis and rapid response mechanisms that can only be achieved through automated computer systems.

The implementation of token lockup periods and their verification before allowing trading also necessitates computer-based timekeeping and automated enforcement mechanisms. This involves tracking multiple time-dependent conditions across numerous tokens simultaneously, a task that would be prohibitively complex and error-prone if attempted manually.

Lastly, the integration with various databases, such as cooperative member databases and property token databases, for real-time verification and record-keeping is a feature that requires sophisticated data management systems. The ability to quickly query, update, and maintain consistency across these databases while processing exchange transactions is only feasible with computer database management systems and cannot be practically achieved through manual record-keeping methods.

Embodiments of the present invention significantly enhance the efficiency and security of property token exchanges by implementing a structured, time-based access system that leverages blockchain technology. Traditional methods of trading fractional ownership in assets often lack the granular control and transparency needed to ensure fair access and maintain market stability. Embodiments of the present invention address these limitations by employing a sequential buying windows approach, which allows for precise control over who can access the market and when, while utilizing blockchain technology to ensure secure and transparent transactions.

For example, the property token exchange system 500 implements a series of timed access windows, each catering to a specific group of potential buyers. This is achieved through the sequential buying windows module 504, which includes specialized components such as the non-holder access window 506, regional member access window 508, global member access window 510, and institutional buyer access window 512. These components work in concert to provide a controlled progression of market access, from non-token holders to institutional buyers. This approach not only promotes ownership diversification but also allows for strategic market management that would be impractical to implement manually.

Furthermore, the system's integration with blockchain technology, as evidenced by the blockchain transfer module 516 and its connection to the blockchain network 522, significantly enhances the security and transparency of token transfers. Each transaction is recorded immutably on the blockchain, creating a verifiable audit trail that was previously unattainable with traditional exchange methods. This not only reduces the risk of fraud but also increases trust in the system, potentially leading to greater market participation and liquidity.

The property token exchange system 500 also addresses the challenge of maintaining market liquidity for tokenized assets, a common issue in fractional ownership markets. By incorporating an institutional buyer access window 512 and mechanisms for identifying and engaging market makers, the system can automatically respond to market conditions such as overpriced listings. This dynamic liquidity management, facilitated by real-time data analysis and automated decision-making processes, represents a significant advancement over traditional exchange systems that often struggle to maintain consistent liquidity.

In conclusion, embodiments of the present invention provide a comprehensive technical solution to the challenges of operating a property token exchange. By leveraging advanced computer systems to implement time-based access controls, blockchain-based transfers, and automated liquidity management, these embodiments create a system that significantly enhances the security, efficiency, and functionality of tokenized asset exchanges. This not only addresses the limitations of traditional methods but also opens up new possibilities for fractional ownership and investment that were previously unattainable.

One embodiment of the present invention is directed to a method for creating a tokenized asset, performed by at least one computer executing computer program instructions stored on at least one non-transitory computer-readable medium. The method includes issuing, to each of a plurality of members of a cooperative, a corresponding membership non-fungible token that serves as proof of membership in the cooperative, thereby issuing a plurality of membership non-fungible tokens to the plurality of members of the cooperative. Each of the plurality of membership non-fungible tokens may be implemented using an ERC-721 standard. In response to approving acquisition of an asset by the cooperative, the method creates a dual ownership structure to create the tokenized asset from the asset. This involves establishing a legal entity for ownership of the asset, generating a property ownership non-fungible token associated with the asset (such as by implementing an ERC-721 standard for the property ownership non-fungible token), and implementing a smart contract (e.g., according to an ERC-3643 standard) to create a plurality of property tokens representing fractional ownership in the tokenized asset. The property ownership non-fungible token associated with the asset and the legal entity together establish parallel digital and legal ownership structures for the asset.

In some embodiments, issuing the plurality of membership non-fungible tokens to the plurality of members of the cooperative involves verifying a prospective member of the cooperative using Know Your Customer (KYC) requirements and issuing a corresponding membership non-fungible token to the prospective member in response to verifying the prospective member using the KYC requirements. Alternatively, issuing the plurality of membership non-fungible tokens may involve issuing an invitation to a prospective member of the cooperative, completing a membership onboarding process for the prospective member, and issuing a corresponding membership non-fungible token to the prospective member after completing the membership onboarding process, thereby adding the prospective member to the plurality of members.

In certain embodiments, the legal entity comprises a Special Purpose Vehicle (SPV) legal entity. Generating the property ownership non-fungible token may involve creating a one-to-one relationship between the property ownership non-fungible token and ownership reflected in the legal entity. Implementing the smart contract may include creating the plurality of property tokens such that each property token represents an equal unit of value based on initial property valuation of the asset. The smart contract may distribute the plurality of property tokens through at least one of an investment club, a property token associate acting as a registered representative, or an indirect investment fund. In some cases, the smart contract comprises a security token contract.

The method may further include distributing the plurality of property tokens to respective digital wallets of the plurality of members of the cooperative, potentially based on investment contributions from the plurality of members. In response to a member losing access to a wallet containing at least one token selected from the group consisting of the member's corresponding membership non-fungible token and property tokens, the method may involve receiving authorization to burn the at least one token, burning the at least one token upon receiving the authorization, and issuing at least one equivalent replacement token to a new wallet for the member, wherein the at least one replacement token has the same value and cost basis as the at least one burned token.

Prior to creating the dual ownership structure and after issuing the plurality of membership non-fungible tokens, the method may involve receiving an acquisition proposal for the asset from one or more members of the cooperative, determining whether to accept the acquisition proposal, and approving acquisition of the asset based on the determination. Determining whether to accept the acquisition proposal may involve conducting a vote by the cooperative members on the acquisition proposal, and approving acquisition of the asset may be based on the vote. Conducting the vote may involve using blockchain-based voting technology to record and verify member votes based on the membership non-fungible tokens, which may include verifying voting eligibility based on ownership of the membership non- fungible tokens and executing the vote according to governance rules specified in organizing documents of the cooperative.

Implementing the smart contract may involve implementing a blockchain-based architecture comprising the ERC-721 standard for the membership non-fungible tokens and the property ownership non-fungible token, and the ERC-3643 standard for the property tokens. The method may also include executing blockchain-based distribution mechanisms to distribute dividends to property token holders and maintain ownership records through smart contracts.

The method may further involve enabling wallet-to-wallet transfer of the property tokens between members of the cooperative via blockchain transactions, which may include verifying membership status of transferring parties through the membership non-fungible tokens and recording transfers through smart contract execution. The membership non-fungible tokens may enable blockchain-based voting, the property ownership non-fungible token may establish digital ownership rights, and the property tokens may enable automated distribution of ownership benefits.

Additional aspects of the method may include receiving a request from a member to list property tokens for sale on a property token exchange, listing the property tokens on the property token exchange, and executing transfer of the listed property tokens via blockchain upon sale. The asset may comprise at least one of real property, a building, an automobile, a loan, energy infrastructure, or a business.

Another embodiment of the present invention is directed to a system for creating a tokenized asset. The system includes at least one non-transitory computer-readable medium storing computer program instructions and at least one computer processor configured to execute the computer program instructions to perform operations. These operations are substantially similar to the method described above for creating a tokenized asset.

A further embodiment of the present invention is directed to a method for operating a property token exchange, performed by at least one computer executing computer program instructions stored on at least one non-transitory computer-readable medium. The method involves receiving a listing of a plurality of property tokens for sale from a member of a cooperative, where the plurality of property tokens represent fractional ownership in a tokenized asset created through a dual ownership structure comprising a legal entity and a property ownership non-fungible token. The method implements a plurality of sequential buying windows for the plurality of property tokens. This includes providing exclusive access to bid on the plurality of property tokens to non-holders of property tokens during a first time period, after expiration of the first time period, providing access to bid on unsold listed property tokens to cooperative members within a regional geolocation of the unsold listed property tokens during a second time period, and after providing regional access, providing access to bid on unsold listed property tokens to cooperative members located anywhere during a third time period. The method also includes executing transfer of sold property tokens between wallets of buyers and sellers via blockchain.

In some embodiments, the method may further include, after expiration of the third time period, providing access to bid on unsold listed property tokens to institutional buyers. Before implementing the plurality of sequential buying windows, the method may involve verifying that a token lockup period has expired and, in response to verifying that the token lockup period has expired, implementing the plurality of sequential buying windows.

Providing exclusive access to bid on the property tokens to non-holders of property tokens during the first time period may involve receiving a bid request from a potential bidder during the first time period, verifying that the potential bidder is a member of the cooperative through a membership non-fungible token, verifying that the potential bidder does not currently hold any property tokens, enabling bidding functionality for the potential bidder in response to successful verification of both membership and non-holder status, and recording the bid request and verification results via blockchain.

Similarly, providing access to bid on any remaining listed property tokens to cooperative members within a regional geolocation of the remaining listed property tokens may involve receiving a bid request from a potential bidder after expiration of the first time period, verifying that the potential bidder is a member of the cooperative through a membership non-fungible token, verifying that the potential bidder's geolocation matches the regional geolocation of the remaining listed property tokens, enabling bidding functionality for the potential bidder in response to successful verification of both membership and regional eligibility, and recording the bid request and verification results via blockchain.

Providing access to bid on unsold listed property tokens to cooperative members located anywhere may involve receiving a bid request from a potential bidder after providing regional access, verifying that the potential bidder is a member of the cooperative through a membership non-fungible token, enabling bidding functionality for the potential bidder in response to successful verification of membership, and recording the bid request and verification results via blockchain.

Providing access to bid on unsold listed property tokens to institutional buyers may involve receiving a bid request from a potential institutional buyer after providing access to cooperative members located anywhere, verifying that the potential buyer is an approved institutional buyer selected from the group consisting of REITs, private equity firms, and DeFi platforms, enabling bidding functionality for the potential institutional buyer in response to successful verification of institutional buyer status, and recording the bid request and verification results via blockchain.

Executing transfer of sold property tokens between wallets of buyers and sellers via blockchain may involve receiving confirmation of a successful bid on a listed property token, verifying membership of a buyer and a seller of the listed property token in the cooperative through respective membership non-fungible tokens of the buyer and seller, executing a smart contract to transfer the listed property token from a wallet of the seller to a wallet of the buyer, recording details of the transfer on blockchain, and updating ownership records maintained through the smart contract. The details of the transfer may include at least one of wallet addresses of buyer and seller, number of tokens transferred, transaction timestamp, or verification status.

Providing access to bid on unsold listed property tokens to institutional buyers may also involve receiving pricing data indicating that listed property tokens are priced above a recommended listing threshold, identifying institutional buyers to serve as market makers, enabling the institutional buyers to provide liquidity by purchasing the listed property tokens, and recording market maker transactions via blockchain. Identifying institutional buyers to serve as market makers may involve identifying at least one of REITs, private equity firms, or DeFi platforms to serve as the market makers.

The method may further include monitoring listing prices relative to recommended listing thresholds, identifying listings requiring market maker liquidity based on pricing, and facilitating institutional buyer purchases to maintain market liquidity for overpriced listings.

A final embodiment of the present invention is directed to a system for operating a property token exchange. The system includes at least one non-transitory computer-readable medium storing computer program instructions and at least one computer processor configured to execute the computer program instructions to perform operations. These operations are substantially similar to the method described above for operating a property token exchange.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A method, performed by at least one computer executing computer program instructions stored on at least one non-transitory computer-readable medium, for creating a tokenized asset, the method comprising:
issuing, to each of a plurality of members of a cooperative, a corresponding membership non-fungible token that serves as proof of membership in the cooperative, thereby issuing a plurality of membership non-fungible tokens to the plurality of members of the cooperative, wherein each of the plurality of membership non-fungible tokens is implemented using an ERC-721 standard;
in response to approving acquisition of an asset by the cooperative, creating a dual ownership structure to create the tokenized asset from the asset, comprising:
establishing a legal entity for ownership of the asset;
generating a property ownership non-fungible token associated with the asset, comprising implementing an ERC-721 standard for the property ownership non-fungible token associated with the the; and
implementing a smart contract according to an ERC-3643 standard to create a plurality of property tokens representing fractional ownership in the tokenized asset;
wherein the property ownership non-fungible token associated with the asset and the legal entity together establish parallel digital and legal ownership structures for the asset.

2. The method of claim 1, wherein issuing the plurality of membership non-fungible tokens to the plurality of members of the cooperative comprises:
verifying a prospective member of the cooperative using Know Your Customer (KYC) requirements; and
issuing a corresponding membership non-fungible token to the prospective member in response to verifying the prospective member using the KYC requirements.

3. The method of claim 1, wherein issuing the plurality of membership non-fungible tokens to the plurality of members of the cooperative comprises:
issuing an invitation to a prospective member of the cooperative;
completing a membership onboarding process for the prospective member; and
issuing a corresponding membership non-fungible token to the prospective member after completing the membership onboarding process for the prospective member, thereby adding the prospective member to the plurality of members.

4. The method of claim 1, wherein the legal entity comprises a Special Purpose Vehicle (SPV) legal entity.

5. The method of claim 1, wherein generating the property ownership non-fungible token comprises creating a one-to-one relationship between the property ownership non-fungible token associated and ownership reflected in the legal entity.

6. The method of claim 1, wherein implementing the smart contract comprises:
creating the plurality of property tokens such that each property token represents an equal unit of value based on initial property valuation of the asset.

7. The method of claim 1, wherein the smart contract comprises a security token contract.

8. The method of claim 1, further comprising distributing the plurality of property tokens to respective digital wallets of the plurality of members of the cooperative.

9. The method of claim 1, wherein prior to creating the dual ownership structure and after issuing the plurality of membership non-fungible tokens:
receiving an acquisition proposal for the asset from one or more members of the cooperative;
determining whether to accept the acquisition proposal; and
approving acquisition of the asset based on the determination.

10. The method of claim 9:
wherein determining whether to accept the acquisition proposal comprises conducting a vote by the cooperative members on the acquisition proposal; and
wherein approving acquisition of the asset based on the determination comprises approving acquisition of the asset based on the vote.

11. The method of claim 10, wherein conducting the vote comprises:
using blockchain-based voting technology to record and verify member votes based on the membership non-fungible tokens.

12. The method of claim 11, wherein using blockchain-based voting technology comprises:
verifying voting eligibility based on ownership of the membership non-fungible tokens; and
executing the vote according to governance rules specified in organizing documents of the cooperative.

13. The method of claim 1, wherein the asset comprises at least one of real property, a building, an automobile, a loan, energy infrastructure, or a business.

14. A system for creating a tokenized asset, the system comprising:
at least one non-transitory computer-readable medium storing computer program instructions; and
at least one computer processor configured to execute the computer program instructions to perform operations comprising:
issuing, to each of a plurality of members of a cooperative, a corresponding membership non-fungible token that serves as proof of membership in the cooperative, thereby issuing a plurality of membership non-fungible tokens to the plurality of members of the cooperative, wherein each of the plurality of membership non-fungible tokens is implemented using an ERC-721 standard;
in response to approving acquisition of an asset by the cooperative, creating a dual ownership structure to create the tokenized asset from the asset, comprising:
establishing a legal entity for ownership of the asset;
generating a property ownership non-fungible token associated with the asset, comprising implementing an ERC-721 standard for the property ownership non-fungible token associated with the asset; and
implementing a smart contract according to an ERC-3643 standard to create a plurality of property tokens representing fractional ownership in the tokenized asset;
wherein the property ownership non-fungible token associated with the asset and the legal entity together establish parallel digital and legal ownership structures for the asset.

15. A method, performed by at least one computer executing computer program instructions stored on at least one non-transitory computer-readable medium, for operating a property token exchange, the method comprising:
receiving a listing of a plurality of property tokens for sale from a member of a cooperative, wherein the plurality of property tokens represent fractional ownership in a tokenized asset created through a dual ownership structure comprising a legal entity and a property ownership non-fungible token;
implementing a plurality of sequential buying windows for the plurality of property tokens, comprising:
providing exclusive access to bid on the plurality of property tokens to non-holders of property tokens during a first time period;
after expiration of the first time period, providing access to bid on unsold listed property tokens to cooperative members within a regional geolocation of the unsold listed property tokens during a second time period;
after providing regional access, providing access to bid on unsold listed property tokens to cooperative members located anywhere during a third time period; and
executing transfer of sold property tokens between wallets of buyers and sellers via blockchain.

16. The method of claim 15, further comprising:
after expiration of the third time period, providing access to bid on unsold listed property tokens to institutional buyers.

17. The method of claim 15, further comprising, before implementing the plurality of sequential buying windows:
verifying that a token lockup period has expired; and
in response to verifying that the token lockup period has expired, implementing the plurality of sequential buying windows.

18. The method of claim 15, wherein providing exclusive access to bid on the at least one property token to non-holders of property tokens during the first time period comprises:
receiving a bid request from a potential bidder during the first time period;
in response to receiving the bid request:
verifying that the potential bidder is a member of the cooperative through a membership non-fungible token;
verifying that the potential bidder does not currently hold any property tokens;
enabling bidding functionality for the potential bidder in response to successful verification of both membership and non-holder status; and
recording the bid request and verification results via blockchain.

19. The method of claim 15, wherein providing access to bid on any remaining listed property tokens to cooperative members within a regional geolocation of the remaining listed property tokens comprises:
receiving a bid request from a potential bidder after expiration of the first time period;
in response to receiving the bid request:
verifying that the potential bidder is a member of the cooperative through a membership non-fungible token;
verifying that the potential bidder's geolocation matches the regional geolocation of the remaining listed property tokens;
enabling bidding functionality for the potential bidder in response to successful verification of both membership and regional eligibility; and
recording the bid request and verification results via blockchain.

20. The method of claim 15, wherein providing access to bid on unsold listed property tokens to cooperative members located anywhere comprises:
receiving a bid request from a potential bidder after providing regional access;
in response to receiving the bid request:
verifying that the potential bidder is a member of the cooperative through a membership non-fungible token;
enabling bidding functionality for the potential bidder in response to successful verification of membership; and
recording the bid request and verification results via blockchain.

21. The method of claim 15, wherein executing transfer of sold property tokens between wallets of buyers and sellers via blockchain comprises:
receiving confirmation of a successful bid on a listed property token;
in response to receiving the confirmation:
verifying membership of a buyer and a seller of the listed property token in the cooperative through respective membership non-fungible tokens of the buyer and seller;
executing a smart contract to transfer the listed property token from a wallet of the seller to a wallet of the buyer;
recording details of the transfer on blockchain; and
updating ownership records maintained through the smart contract.

22. A system for operating a property token exchange, the system comprising:
at least one non-transitory computer-readable medium storing computer program instructions; and
at least one computer processor configured to execute the computer program instructions to perform operations comprising:
receiving a listing of a plurality of property tokens for sale from a member of a cooperative, wherein the plurality of property tokens represent fractional ownership in a tokenized asset created through a dual ownership structure comprising a legal entity and a property ownership non-fungible token;
implementing a plurality of sequential buying windows for the plurality of property tokens, comprising:
providing exclusive access to bid on the plurality of property tokens to non-holders of property tokens during a first time period;
after expiration of the first time period, providing access to bid on unsold listed property tokens to cooperative members within a regional geolocation of the unsold listed property tokens during a second time period;
after providing regional access, providing access to bid on unsold listed property tokens to cooperative members located anywhere during a third time period; and
executing transfer of sold property tokens between wallets of buyers and sellers via blockchain.
